(19) United States
(12) Patent Application Publication
(10) Pub. No.: US 2013/0208880 A1
(43) Pub. Date: Aug. 15, 2013

(54) METHOD AND APPARATUS FOR EVOLUTIONARY CONTACT CENTER BUSINESS INTELLIGENCE

(71) Applicants: David M. Lovy, Blossvale, NY (US); Robert J. Bojanek, Rome, NY (US); Bharat Shah, Acton, MA (US)

(72) Inventors: David M. Lovy, Blossvale, NY (US); Robert J. Bojanek, Rome, NY (US); Bharat Shah, Acton, MA (US)

(73) Assignee: SHOREGROUP, INC., New York, NY (US)

(21) Appl. No.: 13/722,244

(22) Filed: Dec. 20, 2012

Related U.S. Application Data
(60) Provisional application No. 61/677,743, filed on Jul. 31, 2012.
(60) Provisional application No. 61/669,392, filed on Jul. 9, 2012.
(60) Provisional application No. 61/579,286, filed on Dec. 22, 2011.

(51) Int. Cl. H04M 3/51

(52) U.S. Cl. CPC H04M 3/5175
USPC 379/265.03

(57) ABSTRACT

A web-based contact center state engine provides data describing the state of the contact center system and actionable intelligence including key performance indicators. The contact center state engine may be utilized in conjunction with the network monitoring appliance which processes and manages exceptions to the call center data allowing for action, exceptions and escalation, thereby alerting an organization to an issue and providing recommended actions in addition to post event forensic data.

This application claims the benefit of priority to U.S. Provisional Application No. 61/677,743, filed on Jul. 31, 2012, entitled METHOD AND APPARATUS FOR EVOLUTIONARY CONTACT CENTER BUSINESS INTELLIGENCE, and to U.S. Provisional Application No. 61/669,392, filed on Jul. 9, 2012, entitled METHOD AND APPARATUS FOR EVOLUTIONARY CONTACT CENTER BUSINESS INTELLIGENCE, and to U.S. Provisional Application No. 61/579,286, filed on Dec. 22, 2011, entitled METHOD AND APPARATUS FOR EVOLUTIONARY CONTACT CENTER BUSINESS INTELLIGENCE the entire subject matters of each of which are incorporated herein by this reference for all purposes.

### FIELD OF THE INVENTION

This invention relates generally to computer and communication networks and more specifically, to an apparatus and methods for intelligently correlating call event data with network status data in a call center environment.

### BACKGROUND OF THE INVENTION

Historically, contact center monitoring and management is performed with product-specific tools and utilities. Each tool has capability for their own product, but can only make inferences about other product's state through inference. For example, an Intelligent Call Manager (ICM) alert on an Interactive Voice Response (IVR) system offline is helpful, but the intelligent contact manager ICM doesn't know any more than it lost heartbeats. An analyst would next have to explore network, server, and IVR vendor specific tools to isolate and remediate the issue. This process lends itself to inefficiency, inconsistency, and information overload. While un-integrated, vendor-specific tools might be inconvenient and time consuming, the biggest problem is that the engine of these systems, the databases, are also silos.

Accordingly, a need exists for a scalable contact center state engine providing a trustworthy, uninterrupted, unified reality.

A further need exists for a contact center state engine that provides customizable applications, data access, notification tools, and services to allow the right intelligence to reach the right expertise in the right form.

### SUMMARY OF THE INVENTION

A web-based contact center state engine is disclosed and may be utilized in conjunction with the network monitoring appliance for providing data describing the state of the contact center system and actionable intelligence including key performance indicators. Exceptions to the call center data are processed and managed through the network appliance allowing for action, exceptions and escalation, and enabling an organization to know when something needs attention, recommended actions and forensics on what happened once resolved. More specifically, the Sextant Contact Center Business Analytics application, referred to herein as Sextant application 50, is a web-based business intelligence (BI) solution that enables contact center management with the actionable information needed to effectively manage critical business processes and performance. The Sextant application 50 functions as a scalable contact center state engine providing data describing a reliable, unified reality of the contact center environment. The Sextant application provides customizable applications, data access, notification tools, and services to allow the right intelligence to reach the right expertise. The Sextant application provides actionable intelligence in usable formats to associated systems.

The Sextant application may be utilized in conjunction with a network monitoring appliance, such as CaseSentry, commercially available from ShoreGroup, Inc., New York, N.Y. which is described in U.S. Pat. Nos. 7,971,106; 7,600,160; 7,509,540; 7,296,194; 7,197,561; 7,069,480; and 7,028,228; the subject matters which are incorporated herein by this reference for all purposes. The ability to define a key performance indicator in the Sextant application, and have exceptions fed and managed through CaseSentry workflow, is a cornerstone capability of Sextant application BI, allowing for action, exceptions and escalation, and enabling an organization to know when something needs attention, recommends actions and forensics on what happened once resolved.

According to a first aspect of the disclosure, a contact center state engine receives communication event data, typically call event data from one or more sources, and intelligently correlates and assimilates the data for storage into a database. A network appliance on which the call center state engine may be simultaneously, executing monitors the status of objects within the network infrastructure. Exceptions in the data defining the call center state are corroborated with the status of objects in the corresponding network infrastructure to identify issues and suggest possible solutions for resolving performance problems.

According to another aspect of the disclosure, a system for monitoring the state of the communications contact center comprises: a network appliance operably coupled to a network and configured for monitoring status of plural objects within a network infrastructure; B) a contact center state engine operably coupled to a network and configured to: i) receive communication data from a plurality of sources, ii) correlate communication data from plural sources relating to a common parameter, and iii) assimilate the correlated communication data for storage into memory, wherein exceptions in a state of the contact center as determined by the contact center state engine are corroborated with changes in the status of objects in the network infrastructure, as monitored by the network appliance.

According to yet another aspect of the disclosure, method for monitoring the state of the communications contact center comprises: A) receiving data either pushed or pulled from a plurality external data sources; B) correlating a first data type from a first of the plurality of sources with a second data type from a second of the plurality of sources; and C) associating the first and second data types having a correlation into a third data type utilizing a schema extension which represents metadata of a new metric.

### BRIEF DESCRIPTION OF THE DRAWINGS

The above and further advantages of the invention may be better understood by referring to the following description in conjunction with the accompanying drawings in which:

FIG. 1 is a block diagram of a prior art computer system suitable for use with the disclosure;

FIG. 2 is a conceptual illustration of a network environment in which the disclosure may be utilized;

FIG. 3A illustrates conceptually the internal components of the network appliance, call center state engine and external elements within the network environment in accordance with the disclosure;

FIG. 3B illustrates conceptually the internal components of the network appliance, call center state engine and external elements within the network environment in accordance with the disclosure;

FIG. 3C illustrates conceptually the relationship of the data processed by the call center state pension and the infrastructure event data processed by the network appliance relative to memory retention thereof in accordance with the disclosure;

FIG. 3D illustrates conceptually the internal components of the call center state engine within the network environment in accordance with the disclosure;

FIG. 3F illustrates conceptually the relationship of the external sources of contact center information, the ETL layer of the Sextant application, the data retention mechanism and process information forwarded to other recipient mechanisms in accordance with the disclosure;

FIG. 3G illustrates conceptually an exemplary user interface including one or more graphics performance indicators in accordance with the present invention;

FIG. 3H illustrates conceptually an exemplary self-service dashboard user interface in accordance with the disclosure;

FIG. 3I illustrates conceptually an exemplary agent scorecard user interface in accordance with the disclosure;

FIG. 3J illustrates conceptually an exemplary intelligence wizard user interface in accordance with the disclosure;

FIG. 3K illustrates conceptually call flow bundles in accordance with the disclosure;

FIG. 4 is a conceptual block diagram of the network management appliance of the disclosure illustrating the implementation of the performance monitoring component;

FIG. 5 is a conceptual block diagram of the network management appliance of the disclosure illustrating the implementation of the fault monitoring component;

FIG. 6 is a conceptual block diagram illustrating the communication paths between the fault monitoring component of the inventive appliance and the external elements within the network environment;

FIG. 7 is a conceptual block diagram of the decision engine component of the network management appliance of the disclosure;

FIG. 8 is a conceptual block diagram of the case management system component of the network management appliance of the disclosure;

FIG. 9 is a conceptual block diagram of the notification engine component of the network management appliance of the disclosure; and

FIG. 10 is a conceptual block diagram illustrating the communication paths between the performance monitoring component of the inventive appliance and the external elements within the network environment.

### DETAILED DESCRIPTION

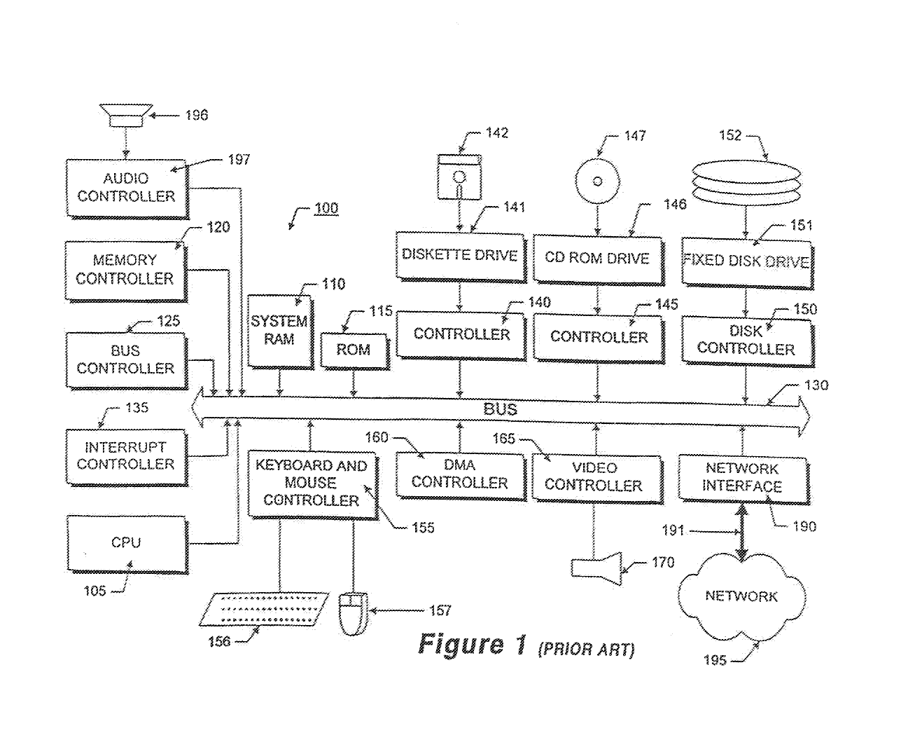

FIG. 1 illustrates the system architecture for a computer system 100, such as a Dell XPS 8500 or other similar or dissimilar computers, commercially available from Dell Computer, Dallas Tex., on which the invention can be implemented. The exemplary computer system of FIG. 1 is for descriptive purposes only. Although the description below may refer to terms commonly used in describing particular computer systems, the description and concepts equally apply to other systems, including systems having architectures dissimilar to FIG. 1.

The computer system 100 includes a central processing unit (CPU) 105, which may include a conventional microprocessor, a random access memory (RAM) 110 for temporary storage of information, and a read only memory (ROM) 115 for permanent storage of information. A memory controller 120 is provided for controlling system RAM 110. A bus controller 125 is provided for controlling bus 130, and an interrupt controller 135 is used for receiving and processing various interrupt signals from the other system components. Mass storage may be provided by diskette 142, CD ROM 147 or hard drive 152. Data and software may be exchanged with computer system 100 via removable media such as diskette 142 and CD ROM 147. Diskette 142 is insertable into diskette drive 141 which is, in turn, connected to bus 130 by a controller 140. Similarly, CD ROM 147 is insertable into CD ROM drive 146 which is connected to bus 130 by controller 145. Hard disk 152 is part of a fixed disk drive 151 which is connected to bus 130 by controller 150.

User input to computer system 100 may be provided by a number of devices. For example, a keyboard 156 and mouse 157 are connected to bus 130 by controller 155. An audio transducer 196, which may act as both a microphone and a speaker, is connected to bus 130 by audio controller 197, as illustrated. It will be obvious to those reasonably skilled in the art that other input devices such as a pen and/or tablet and a microphone for voice input may be connected to computer system 100 through bus 130 and an appropriate controller/software. DMA controller 160 is provided for performing direct memory access to system RAM 110. A visual display is generated by video controller 165 which controls video display 170. Computer system 100 also includes a network adapter 190 which allows the system to be interconnected to a local area network (LAN) or a wide area network (WAN), schematically illustrated by bus 191 and network 195.

Computer system 100-102 are generally controlled and coordinated by operating system software. The operating system controls allocation of system resources and performs tasks such as process scheduling, memory management, and networking and I/O services, among other things. In particular, an operating system resident in system memory and running on CPU 105 coordinates the operation of the other elements of computer system 100. The present invention may be implemented with any number of commercially available operating systems including UNIX, Windows NT, Windows 2000, Windows XP, Linux, Solaris, etc. One or more applications 220 such as the contact center state engine application may execute under control of the operating system 210. If operating system 210 is a true multitasking operating system, multiple applications may execute simultaneously.

In the illustrative embodiment, the present invention may be implemented using object-oriented technology and an operating system which supports execution of object-oriented programs. For example, the inventive system may be implemented using a combination of languages such as C, C++, Perl, PHP, Java, HTML, etc., as well as other object-oriented standards.

In the illustrative embodiment, the elements of the system are implemented in the C++ programming language using object-oriented programming techniques. C++ is a compiled language, that is, programs are written in a human-readable script and this script is then provided to another program called a compiler which generates a machine-readable numeric code that can be loaded into, and directly executed by, a computer. As described below, the C++ language has certain characteristics which allow a software developer to easily use programs written by others while still providing a great deal of control over the reuse of programs to prevent their destruction or improper use. The C++ language is well-known and many articles and texts are available which describe the language in detail. In addition, C++ compilers are commercially available from several vendors including Borland International, Inc. and Microsoft Corporation. Accordingly, for reasons of clarity, the details of the C++ language and the operation of the C++ compiler will not be discussed further in detail herein. The program code used to implement the present invention may also be written in scripting languages such as Peri, Java Scripts, or non-compiled PHP. If required, the non-compiled PHP can be converted to machine readable format.

Network Communication Environment

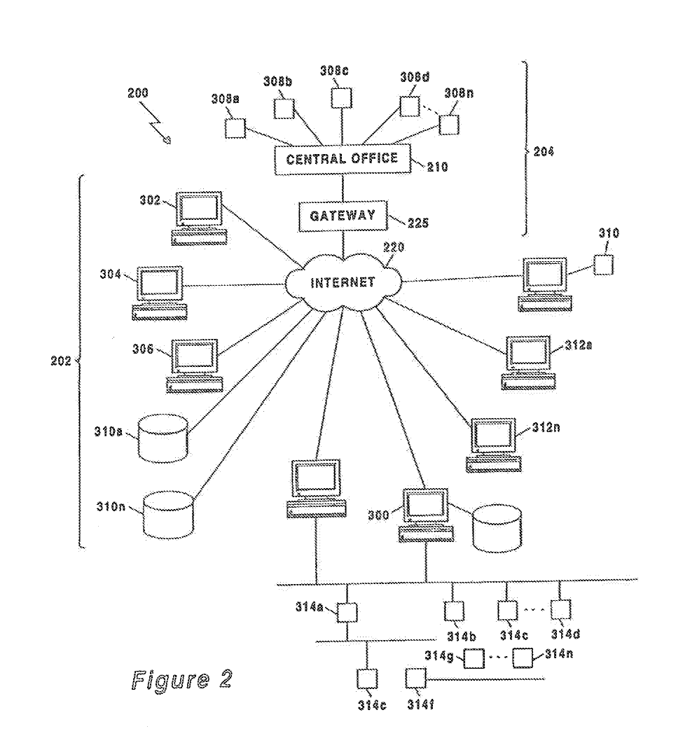

FIG. 2 illustrates a telecommunications environment in which the invention may be practiced such environment being for exemplary purposes only and not to be considered limiting. Network 200 of FIG. 2 illustrates a hybrid telecommunication environment including both a traditional public switched telephone network as well as packet-switched data network, such as the Internet and Intranet networks and apparatus bridging between the two. The elements illustrated in FIG. 2 are to facilitate an understanding of the invention. Not every element illustrated in FIG. 2 or described herein is necessary for the implementation or the operation of the invention.

Specifically, a packet-switched data network 202 comprises a network appliance 300, a plurality of processes 302-306, plurality of monitored devices 314a-n, external databases 310a-n, external services 312 represented by their respective TCP port, and a global network topology 220, illustrated conceptually as a cloud. One or more of the elements coupled to global network topology 220 may be connected directly through a dedicated connection, such as a T1, T2, or T3 connection or through an Internet Service Provider (ISP), such as America On Line, Microsoft Network, CompuServe, etc.

A gateway 225 connects packet-switched data network 202 to circuit switched communications network 204 which includes a central office 210 and one or more traditional telephone terminating apparatus 308a-n. Circuit switched communications network 204 may also include, although not shown, a traditional PSTN toll network with all of the physical elements including PBXs, routers, trunk lines, fiber optic cables, other central offices etc. Terminating apparatus 308a-n may be implemented with either a digital or analog telephone or any other apparatus capable of receiving a call such as modems, facsimile machines, cellular telephones, etc., such apparatus being referred to collectively hereinafter as a terminating apparatus, whether the network actually terminates. Further, the PSTN network may be implemented as either an integrated services digital network (ISDN) or a plain old telephone service (POTS) network.

Each network consists of infrastructure including devices, systems, services and applications. Manageable network components utilize management mechanisms that follow either standard or proprietary protocols. Appliance 300 supports multiple interfaces to manageable devices from various points within its architecture, providing the flexibility to monitor both types of network components.

Components that can be managed using standard or public protocols (including items such as routers, switches, servers, applications, wireless devices, IP telephony processes, etc.) are designed under the premise that such components would reside in networks where a network management system is deployed. Such devices typically contain a MIB (Management Information Base), which is a database of network management information that is used and maintained by a common network management protocol such as SNMP (Simple Network Management Protocol). The value of a MIB object can be retrieved using SNMP commands from the network management system. Appliance 300 monitors the raw status events from such infrastructure directly using various standard protocol queries through a Status Poller 330 and a Trap Receiver 332, as explained hereinafter.

Network components that were not designed with network management applications may have internal diagnostics capabilities that make it possible to generate an alarm or other data log. This data may be available via an interface and/or format that is proprietary in nature. Such systems may also have the ability to generate log files in text format, and make them available through supported interfaces such as e-mail. If event processing capability is needed, appliance 300 can monitor such network components through custom status plug-ins modules.

Sextant application 50 and network appliance 300 are interoperable with existing legacy communication and networking infrastructure which comprise the contact center environment, typically including Wide Area Network (WAN) and Local Area Network (LAN) infrastructure for current data networking as well as Public Switched Telephone Network (PSTN) transport facilities and services.

Sextant Contact Center State Engine Application

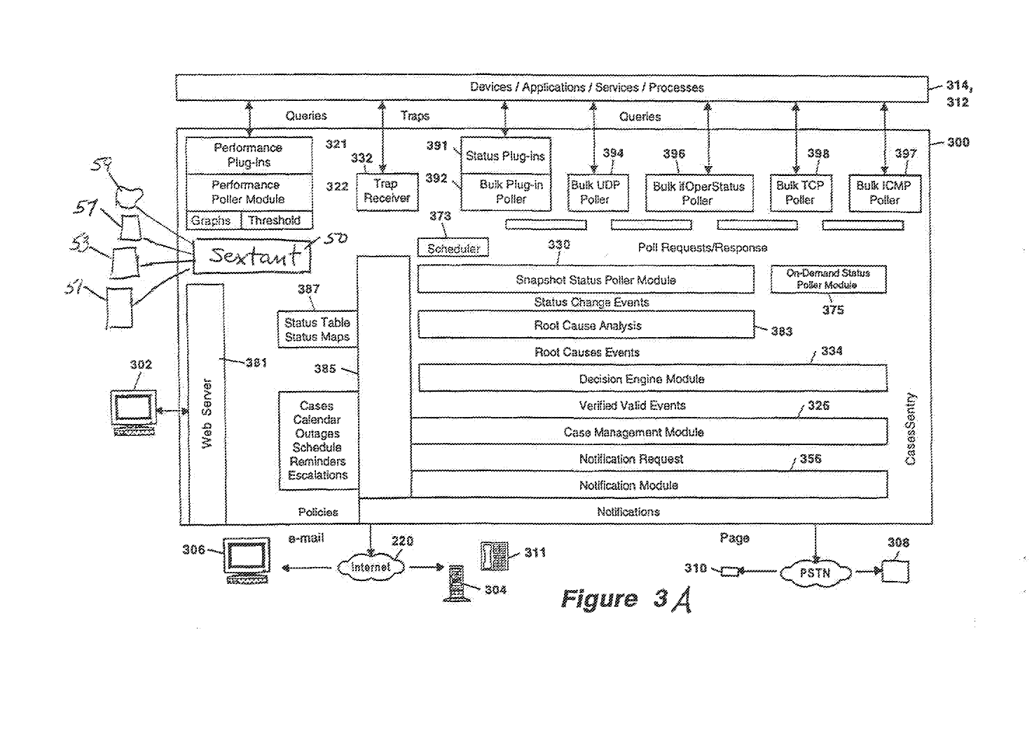

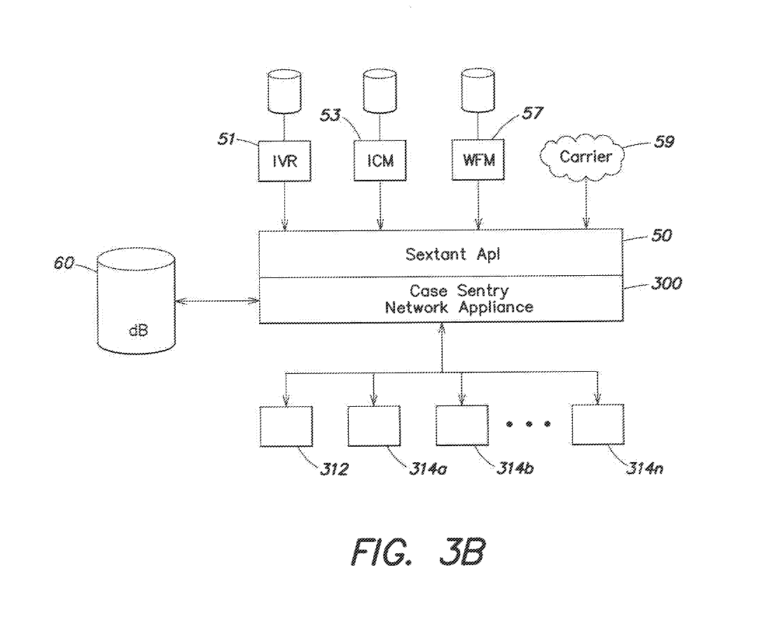

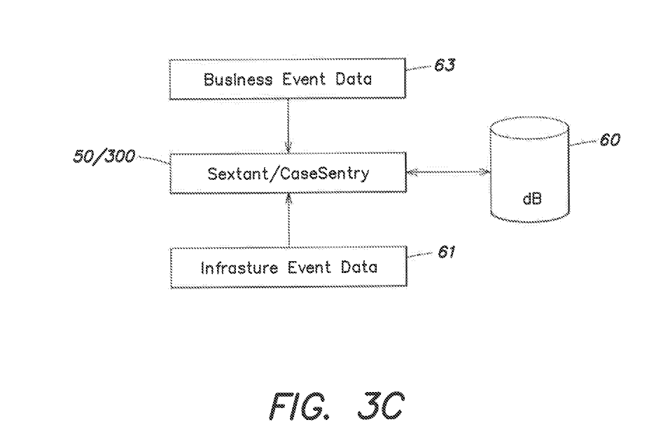

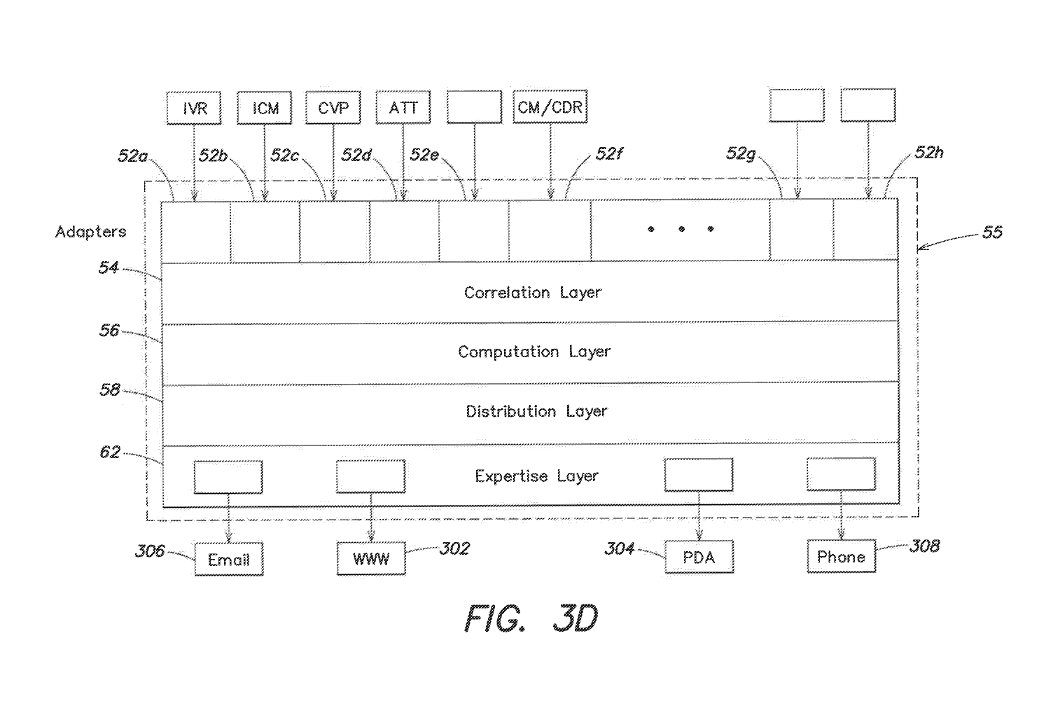

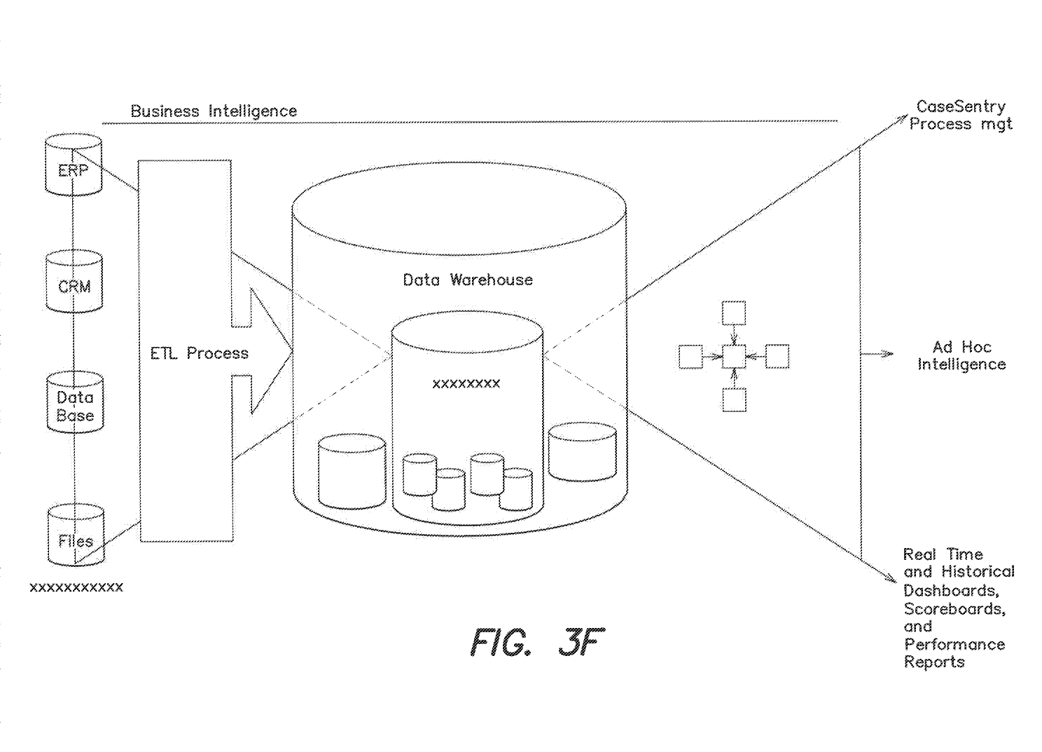

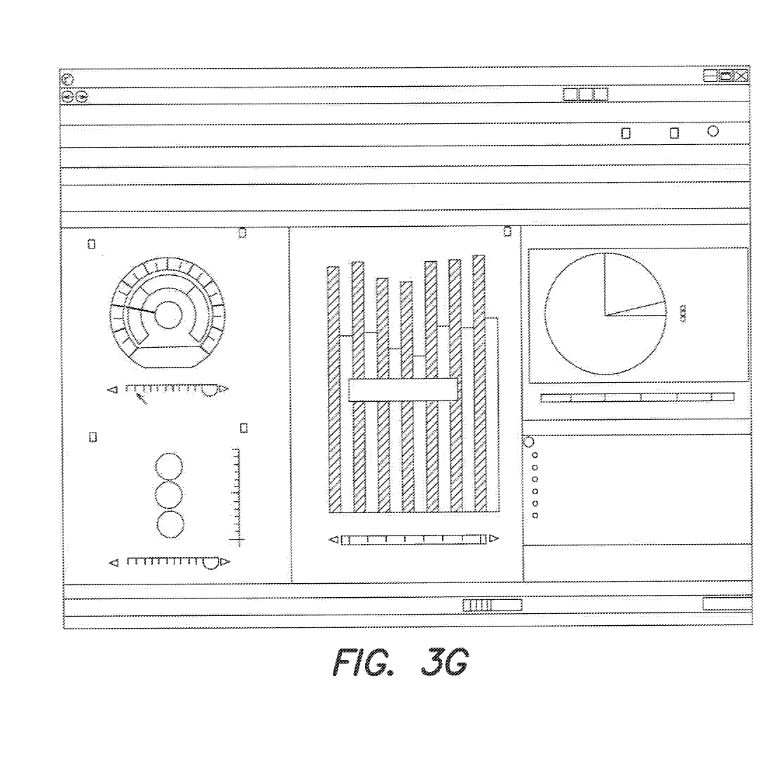

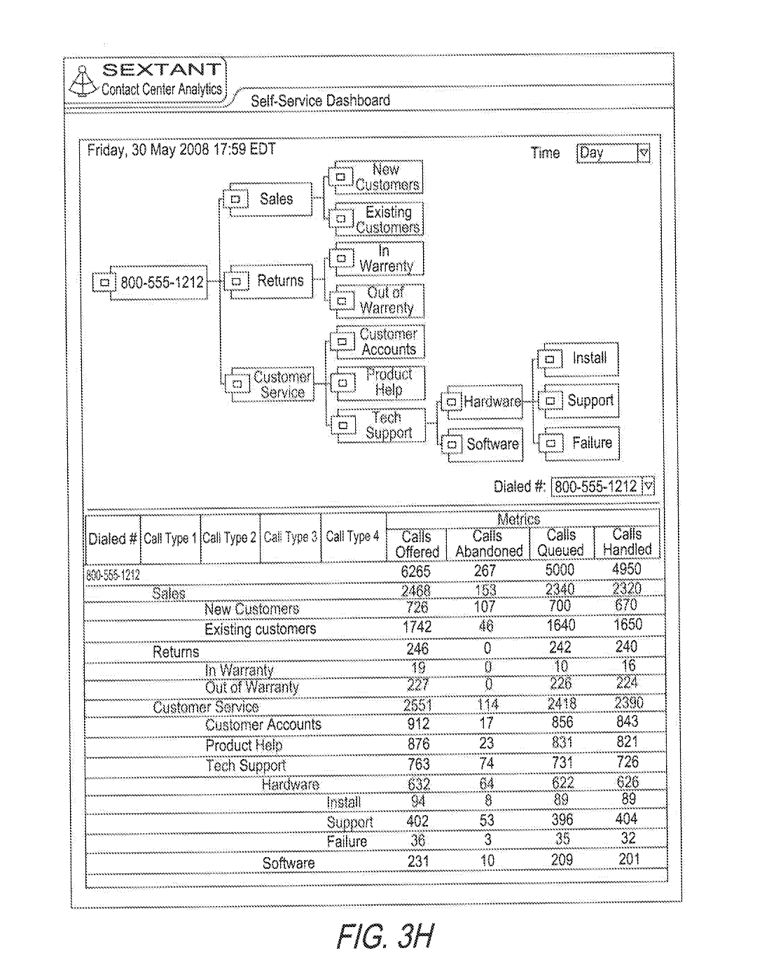

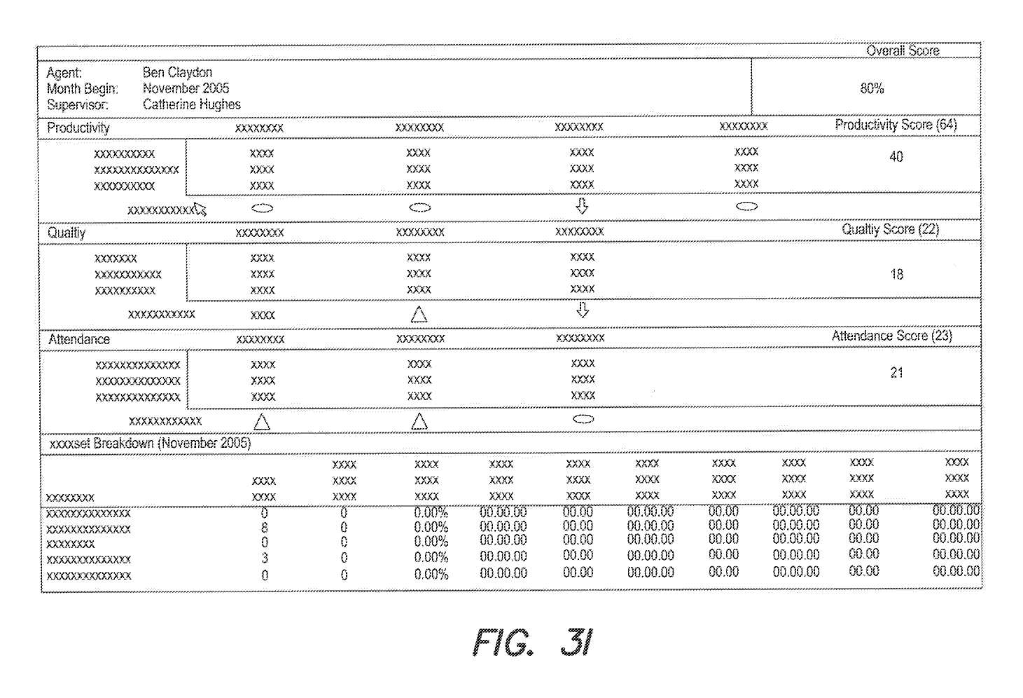

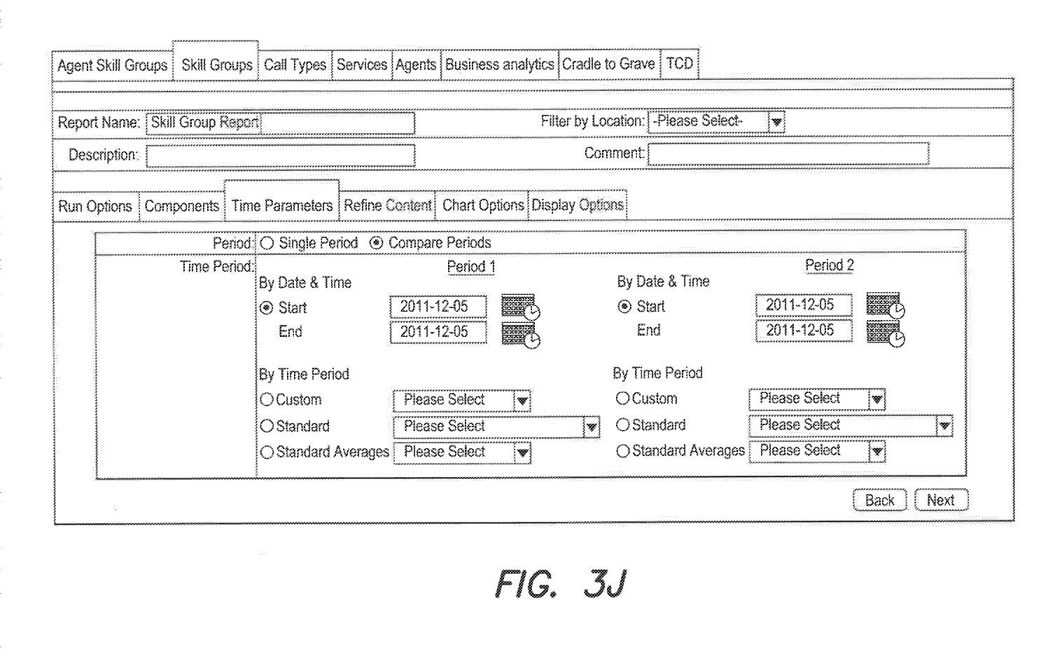

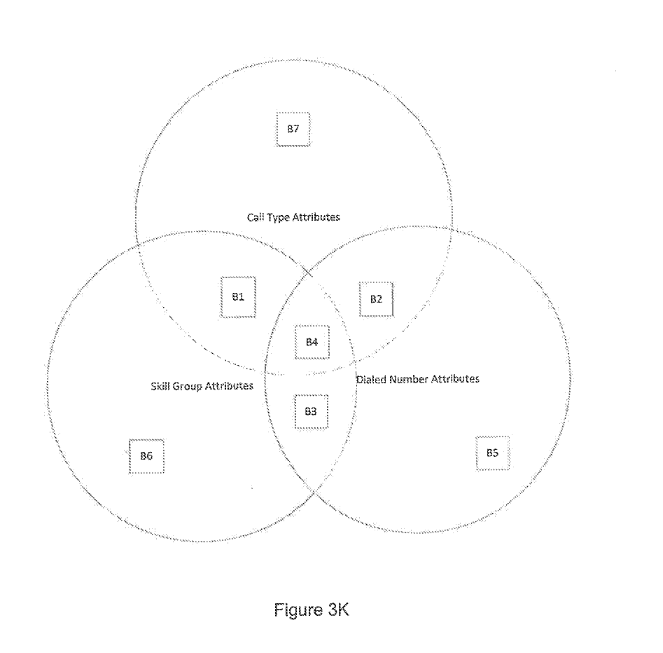

In the illustrative embodiment, except for specific interface hardware, network appliance 300, referred to hereafter as simply as “appliance 300”, may be implemented as part of an all software application which executes on a computer architecture similar to that described with reference to FIG. 1. Similarly, as illustrated in FIG. 3A, the Sextant application 50, may also be implemented as part of an all software application which executes on a computer architecture similar to that described with reference to FIG. 1, either separate from, or as part of appliance 300, as described herein.

Sextant application 50, as illustrated in FIGS. 3A-3F, functions as a scalable contact center state engine providing data describing a reliable, unified reality of the contact center environment. As illustrated in FIG. 3D, in the illustrative embodiment, sextant application 50 comprises, an extract transform and load (ETL) module 55 which may be further subdivided into one or more sub-component modules including adapters 52a-n for interfacing with sources of communication event data, a correlation layer 54 for correlating disparate received data, a computation layer 56 for summarization and creation of new data metrics, and a distribution layer 58 for interacting with one or more external recipients. Unlike traditional solutions that are limited to reporting on raw data, Sextant application 50 utilizes correlation layer 54 and computation layer 56 to incorporate contact center's business processes, data access security requirements, geographical locations, role-based views, groupings and financial detail to create a rich set of metadata that may then be presented by distribution layer 58 with a powerful real-time dashboard and historical report visualizations, as illustrated in FIGS. 3G-J. As such, Sextant application 50 provides a complete turnkey contact center business intelligence solution that includes management consultation, system implementation and ongoing application and systems support.

Diverse Data Sources

Sextant application 50 addresses the disparate data sources dilemma as a multi-layer challenge analogous to the OSI model, Each module layer of Sextant application 50 builds off the other layer in order to realize a higher order purpose. The layers of application 50 are Infrastructure 100, Extract Transform Load (ETL) 55, Distribution 58, and Expertise 62. At the base of the layer hierarchy is the enterprise infrastructure 100 on which sextant application 50 executes. The next layer, the ETL layer 55, includes adapters 52, correlation module 54 and computation module 56. In the illustrative embodiment, the disclosed ETL layer process is not just a matter of copying database rows to a common repository. Instead, each ETL layer 55 facilitates the transformation of silos of disparate data from multiple sources through the use of intelligent correlation and computation of new data metrics to logically “connect” these systems through effective schema extensions which form the basis for rich and intuitive metadata. To perform such transformation, application 50 utilizes domain expertise and data systems deployment knowledge. In order to function as an organizational state engine of the contact center environment, Sextant application 50 follows the same tenants identified in the infrastructure layer. As such, Sextant application 50 is a carrier-class, highly scalable, and fault tolerant system designed to support, most commercially available contact center infrastructure, including, but not limited to, the complete Cisco product line, including UCCX deployments, commercially available from Cisco Systems, San Jose, Calif.

Referring to FIGS. 3B and 3D, ETL layer 55 of Sextant application 50 utilizes adapters 52a-n to systematically acquire contact center metrics from diverse sources across a contact center, such as the Cisco Unified Contact Center Enterprise, including carrier networks 59, IP and TDM contact centers 53, IVR systems 51, social media scanners, databases, desktop applications, agents and other resources, and stores such data in its large-scale database 60 which may be separate from or portion of the database utilized by network appliance 100, as described herein.

Referring to FIG. 3D, adapter 52a-n may be implemented with code modules which are designed to receive data either pushed or pulled from external data sources and to provide such data in a format useful to correlation layer 54. Correlation layer 54 may comprise one or more searching algorithms which analyzes data from one of adapters 52a-n and searches for data from another adapter related to any similar event. For example, data received through a ‘first adapter indicating the termination of a call as detailed in a Call Detail Report at a specific instance may be correlated with a time correlation search algorithm to data received through another adapter representing the presentation of an audio cue from an IVR system. In such example, the time correlation search algorithm looks for data representing specific types of events which have occurred within a particular window of time, e.g. +/− three seconds, of another event, such as presented by data received through another adapter. Similarly, another correlation algorithm may search specifically for data representing parameters typically associated with another type of data received through another adapter which may not be related to time but may be associated through another predefined or user-defined relationship, for example, data relating to all communications handled by a specific contact center agent. Through the use of multiple correlation algorithms, relationships may be established among data from disparate sources.

Once relationships are established by correlation layer 54, computation layer 56 summarizes data having established correlations or relationships and bundles or associates the data into new useful metrics utilizing schema extensions which may be accommodated within the record structure of database 60 and which form the basis for intuitive metadata which may be presented graphically by distribution layer 58 in one or user interface formats, as explained hereinafter.

Call Flow Bundles

A Call Flow Bundle is a grouping of existing call center configuration objects that have been extended with user-defined attributes. The ability to “tag” related call center configuration objects with descriptive attributes allows for meaningful reporting and analytics on business performance. This ability is particularly useful in larger organizations, which often require extensive configuration definition and produce a huge volume of related performance data as a result of operations. Disclosed is an easy to administer ability to tag objects with attributes, and a proprietary mechanism to utilize this abstraction to construct focused queries on these large data sets.

As used herein, a Call Flow is the logical and physical “path” needed to service customer contacts. A customer is anyone attempting to contact (or be contacted by) the service organization. Many contact centers service a variety of internal and/or external customers. An increasing number of service organizations multiple communication mechanisms in addition to phone calls, including, but not limited to email, text field conferencing, chat, and social media, to communicate with their customers, hence the name Contact Center. The Call Flow Bundles described herein are applicable for all these contact types, however, the traditional phone channel is used to describe Call Flow Bundles in an exemplary embodiment.

Many configuration objects are required to properly provision a call center—trunk lines, dialed numbers, call types, skill groups, agent teams, supervisors, agents, and phone settings, to name a few. Call types and skill groups are particularly important. Call types represent the nature of the call while skill groups represent who is handling the call. Large contact centers can literally have thousands of call types and hundreds of skill groups. In addition, Call types can change during the course of a customer call depending on caller service selection(s) and service delivery expectations. For example, a call to a specific 800 number may start at a “main menu” call type (CT) for language selection, and then possibly traverse a sub-selection (sales or service) CT, a “self-service” CT, an “agent” CT, a supervisor transfer CT, and a voicemail CT all in one call. Such simplified call example has 1 dialed number, 6 call types, and 2 skill group objects all involved with one contact. The reader can appreciate that if this or a similar context scenario is repeated thousands of times, with slight variations, the complexity of service reporting starts to become evident.

Individuals looking for data in their respective areas (service mgt, operations, compliance, and marketing are common) previously had to look for their data in the information silos of the configuration object, i.e. “Call Type Report” or “Skill Group Report”. These silos of data must be manipulated and constrained manually through query and with some underlying knowledge of the dataset, possibly causing incomplete and inconsistent results. Disclosed herein is a system and techniques with the ability to ascribe common attribute(s) amongst different objects allowing for easy reporting based on a subset of the information using common bundles.

FIG. 3K illustrates Call Flow Bundles B1-B7 conceptually as a collection of Call Type, Skill Group and Dialed Number attributes, some of which are shared and others of which some are not shared. Each circle represents 1 to N attribute tags. Each Call Flow Bundle can have unique attributes, such as bundles B5, B6, and B7, or can share attributes with one (bundles B1, B2, B3) or multiple reporting objects (bundle B4). Utilizing the system and techniques disclosed herein, a user can run a report on Bundle 4 and filter only the report items at the intersection of the all three configuration objects, with no need for extracting and integrating different report types. In addition, such report may be automatically provided to the user as actionable business intelligence rather than three different reports for the user to sift through and correlate before analyzing.

The decision of specific attribute assignments can be made at various levels, depending on organizational preference. Corporate standards can be set and enforced using the Report Templates scope, which ensure consistent implementation and use. Departmental bundles can also be defined and implemented in similar fashion. Even individual “power users” can define and tag objects with transient objects for ad-hoc analysis. The ability to extend existing schemas with user defined attributes and to provide a data-mash that filters these attribute bundles provides an analytical ability not yet delivered in current contact center analytic space.

Distribution Layer

The Extract Transform Load (ETL) layer 55 effectively provides the unified state of the entire contact center operation and focuses on availability, performance, and predictability to the next layer, the distribution layer 58. The distribution layer 58 provides intelligent useful information to various recipients, typically people within an organization. Since in a large operation, people may be organized by a variety of criteria including line of business, location, and function, managing data access amongst disparate data sources is a challenge. Application 50 allows configurable business logic to enable customer specific business process and organizational structure. Organizational hierarchy, user roles and access may be easily established utilizing user-defined parameters. Groupings of related items in a call flow can be organized and tagged with user (customer) defined attributes and organized into logical bundles. In this manner, call flow bundles can literally collapse dozens or hundreds of related call types into one or a few logical bundles, making for more relevant intelligence.

Placeholder For Hierarchy

In addition to an organizations people, Sextant application 50 provides actionable intelligence in usable formats to associated systems. A network monitoring appliance, such as network appliance 300 and, may be utilized in conjunction with the Sextant application 50, illustrated in FIG. 3C, enables business event data 63 and infrastructure event data 61 to be correlated via ETL layer 55 and stored in database 60 for later retrieval or reporting, as part of the business intelligence by the distribution layer 58 in the matters described herein. The ability to define a key performance indicator in application 50, and have exceptions fed and managed through the appliance 300 workflow, is a cornerstone capability of the application 50 business intelligence, allowing for action, exceptions and escalation, and enabling an organization to know when something needs attention, recommends actions and forensics on what happened once resolved.

Distribution layer 58 can also provide certain automatic-pilot intelligence to the underlying subsystems in an enterprise. Based on a Key Performance Indicator (KPI), an Intelligent Call Manager (ICM) script can modify call distribution or an IVR can update service announcements. Workforce management systems can be updated with accurate and reliable facts. Call recording solutions can trigger for agents who may be having training or other issues. Outbound campaigns can fire to summons contingency staff to support spikes and other organizational anomalies; just a few examples of the intelligence which may be embodied within distribution layer 58. Distribution layer 58 is capable of generating business intelligence data as described herein in any number of different formats, including traditional reporting formats or more innovative dashboard user interfaces with graphic metric mechanisms. Any of the following categories of information may be provided:

Contact Center Performance Management
Individual/team/site/region/enterprise of multiple call handling metrics
Agent Scorecards
Interaction analytics with speech mining

Consolidated Management Information Reporting
End-to-end call detail reporting
ACD, CTI, Multi-channel routing components, WFM, N8NN metrics
Access to legacy system MI Reporting Data
End user training through VoD

Expertise Layer

The Expertise layer 62 is the connection between people and the Sextant application 50. While the distribution layer 58 deals with who sees what, the expertise layer 62 handles how they see it and what they do with it. Expertise layer 62 unlocks missing business intelligence to enable management expertise by utilizing the distribution layer's access definitions, roles, groupings, KPI's and other state data to either push intelligence or allow it to be pulled by experts. In Sextant application 50 this navigation is done through traditional report templates, real-time dashboards, performance scorecards, ad-hoc reporting wizards, and through in-depth, multi-dimensional Online Analytics And Processing (OLAP). Report Templates may be real-time or interval-based, and, in addition to the “standard” reports, are updated to include Sextant application constructs like Call Flow Bundles, KPI's and detailed agent performance as well. FIG. 3F illustrates conceptually the relationship of the external sources of contact center information, the ETL layer of the Sextant application 50, the data retention mechanism and process information forwarded to other recipient mechanisms in accordance with the disclosure.

Placeholder for Wireframe Report

Dashboards may provide operations management expertise with ad-hoc and pre-determined analysis based on departmental or organizational goals. Often used as a snapshot of current state of the contact center or any particular aspect thereof, dashboards can include visual graphics to assist in presentation and recognition. In Sextant application 50, dashboards transcend the subsystems within the system. Call Flow bundles for example, can include IVR self-service, ICM calltypes, ICM skill groups, and post-call processing. FIG. 3G illustrates conceptually an exemplary user interface including one or more graphics performance indicators in accordance with the disclosure.

The dashboards of Sextant application 50 give relevant visualization information, but also support drilldown capabilities to acquire supporting facts and insight as shown the self-service dashboard. FIG. 3H illustrates conceptually an exemplary self service dashboard user interface in accordance with the disclosure.

Scorecards

FIG. 3I illustrates conceptually an exemplary agent scorecard user interface in accordance with the disclosure. Generally the audience for scorecards would be executive expertise and the focus would be strategic. Scorecards can be hybrid dashboards coupled with traditional reporting, including operational and financial performance trends, exceptions, and forecasting. Scorecards usually have predefined structure based on overall business objectives, but can also be created with the Sextant application Intelligence Wizard. Like dashboards, scorecards provide drilldown capability. Sextant application provides a built-in agent ranking scorecard capability that leverages distribution organizational layer definitions.

Intelligence Wizard

FIG. 3J illustrates conceptually an exemplary intelligence wizard user interface in accordance with the disclosure. The Sextant application Intelligence Wizard is a tool for users to create their own views of the Sextant application information. The wizard allows ad-hoc analytics and exploration without having to know SQL and complex reporting packages. The Wizard also leverages data permissions and user accessibility defined in the distribution layer 58. This allows Wizard users the freedom to explore only the information available to them through policy. Wizard users can save and modify their own intelligence designs and have the ability to publish their work to other users or groups.

State Reality

The layers that comprise Sextant application 50—the infrastructure 100, ETL layer 55 and its respective sub-components or layers, distribution layer 58, and the expertise 62 establish Sextant application 50 as the enterprise's state engine, representing what is happening and what has happened. The fact that the systems relationships, call center domain correlations, and metadata are provided to all appropriate users at the same time makes Sextant application the organizations true reality. Previously, all the individual systems had their own version of reality, each a little different than the other. Even on a good day where everything is running smoothly, that variance in reality is a problem. It leads to potentially false assumptions on business performance, rouge distributed exports to editable formats, and soft intelligence at best. The return on investment to addressing this lack of precision relative to business process can be enormous in and of itself. An IVR system failure may be measured in lost sales, service, or other key performance indicators. Here, that variance in reality is associated with downtime, finger pointing, problem ownership, and other tactical problems.

Other issues facing call center management also suffer from distributed perceptions of reality. A good example would be cradle to grave (CTG) reporting. The ICM call detail tables provide a very good version of CTG reality. It brought the whole industry up a notch in the mid 1990's. But the evolution is incomplete because of multimedia, VOIP, and CRM extensions. Calls and contacts originate in the PSTN, intranet, email, website, or social media, but ICM doesn't see that detail. Calls and contacts are received (or just as important, rejected) by gateways, and the ICM doesn't see that. Calls may be processed in IVR systems well before ICM sees them. Calls may be delivered to non-monitored agents, extensions, or transferred to survey systems, and ICM doesn't see that. Lastly, calls generating business process exception (read CaseSentry) and requiring follow up are certainly not seen by ICM.

Sextant application 50 on the other hand, has a complete view of the associated individual systems. The reality is the amalgam of all the systems involved in the contact. Sextant's CTG intelligence is a complete representation of caller experience or of system failures. Sextant application 50 is connected to originating systems like carriers, email engines, websites, and social scanners. Sextant application is connected with gateways and networks. Sextant application is connected to ICM and ACDs. Sextant application is closely coupled with and executes on the Case Sentry, where business process can be repeatedly implemented.

Appendix A lists several CTG use example that illustrates the problematic state of the prior art in a given scenario and how the disclosed system may more efficiently resolve such issues in each scenario utilizing. Sextant application 50 alone or in conjunction with CaseSentry network appliance 100. These examples illustrate the complexity of a large enterprise contact center environment and shows how when broken down into its constituent parts, an organization has the ability to derive actionable information from what appeared to be previously unrelated noise.

The differentiating capabilities and benefits of Sextant application 50 over prior art solutions include:
Industrial strength, integrated, multisource ETL and data store resulting in a trustworthy source of contact center intelligence.
Easy-to-configure hierarchy and data access policy to define KPIs and ensure data integrity to all levels of organizational expertise.
Integration with CaseSentry network appliance enables operational and KPI-specific workflow, email, escalation, and the ability to act as desired.
Call Flow Bundles, which provide easy to configure groupings of like characteristics and the ability to assign meaningful attributes for additional intelligence.
Easy to use Intelligence Wizard, which enables non-programmer expertise to generate ad-hoc views and custom intelligence . . . only on the data to which they have access. The Wizard also allows the business to generate public reports to be used in support of organizational goals.
Comparative interval analysis through advanced OLAP Cubes allows users to understand relative trends by comparing previous results to current performance.
Complete Cradle to Grave Contact Detail intelligence provides rich reporting and deep-dive ad-hoc analysis previously unavailable.
Visualization of call flows enables the ability to understand bottlenecks, identify improvements, and perform what-if analysis.
Built-In operational report templates with Sextant application extensions like agent rankings allow corporate expertise to start using Sextant application right away.
Sextant application can provide to clients who would prefer not to be involved with the infrastructure details and can accelerate the deployment and startup costs associated with such a powerful capability.

In addition to the foregoing, Sextant application 50 may be configured within the contact center environment to perform any of the additional functionalities:
Agent-initiated Emergency Alert/Recording
Wallboard/Readerboard Integration
Real-Time Monitoring—Call, Agent State, Screen
Call Recording and Screen Capture—
   100% Call Recording, 6 month retention
Post Call Survey
Security Requirements (Egov; OMB; SSA; OESAS; etc.)
Encryption of stored sensitive information
ADA Section 508 Compliance

Sextant application 50 may be configured with one or more of the following options described below.

Hosted/Dedicated VoIP Contact Center Solution Options
Single logical IP based system for all sites
Advanced Network Call Routing
CTI
TDD support
Consolidated reporting
High-availability
Geographic redundancy across multiple sites with fractional capacity in each site
Capacity for predetermined number of inquiries per second
CER/E911
Local site PSTN trunking for Fax, Security Alarm, etc.
Queue treatments include messages, music, EWT announcements
Scheduled Voice Callback
Live Monitoring
Agent Voicemail
Workforce Management and Performance Optimization Suite

N8NN Applications
24/7 availability
Speech Enabled for English and Spanish (United States, Puerto Rico, the US Virgin Islands, American Samoa, Guam, and the Northern Marianas Islands)
Specific SLAs for recognition rates on certain grammars
Caller identification validated against enterprise records, deliver calls to agents with screen pop.
Speech recognition for Main Menu (and any other automated applications)
Interactive Transcription of Automated Applications
   Forms request
   Pamphlet request
Informational Messages
Computer Telephony (CT) Applications
Password Services/Account Status
Return to Main Menu
Automated Appointment
Account Number Verification
Spanish Automated Services Applications
Scheduled Voice Callback (SVC)
Interfaces with enterprise servers, distributed platforms, Customer Relationship Management (CRM) applications, databases, or other back-end processes, data, and information.

Call Routing
Skills based
Multi-channel blended agents
Real-time and historical reporting
Routing criteria based on mainframe integrations
Enterprise routing, static and dynamic, with some local routing rules for Hawaii and US Territories

CaseSentry Network Appliance

As noted previously, Sextant application 50 works in conjunction with a network appliance 100, such as the CaseSentry network appliance commercially available from ShoreGroup Corporation, New York, N.Y. as described herein, for identifying, diagnosing, and documenting problems in computer networks. The devices and process available on a network, as well as grouping of the same, are collectively referred to hereafter as “objects”. Accordingly, a monitored or managed object may be physical device(s), process(es) or logical associations or the same. According to one aspect of the invention, the network appliance comprises one or more a polling modules, a decision engine, a database and a case management module. The network appliance monitors objects throughout the network and communicates their status and/or problems to any number of receiving devices including worldwide web processes, e-mail processes, other computers, PSTN or IP based telephones or pagers.

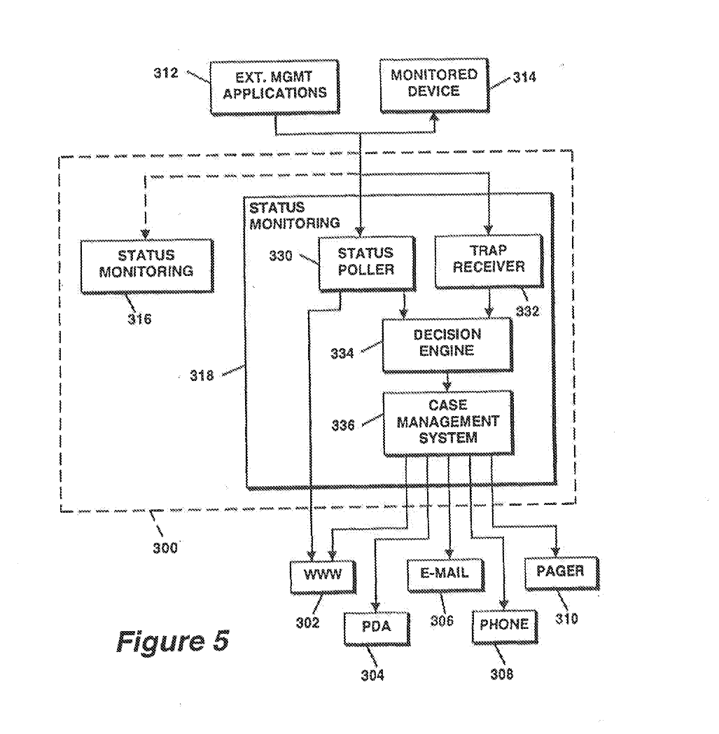

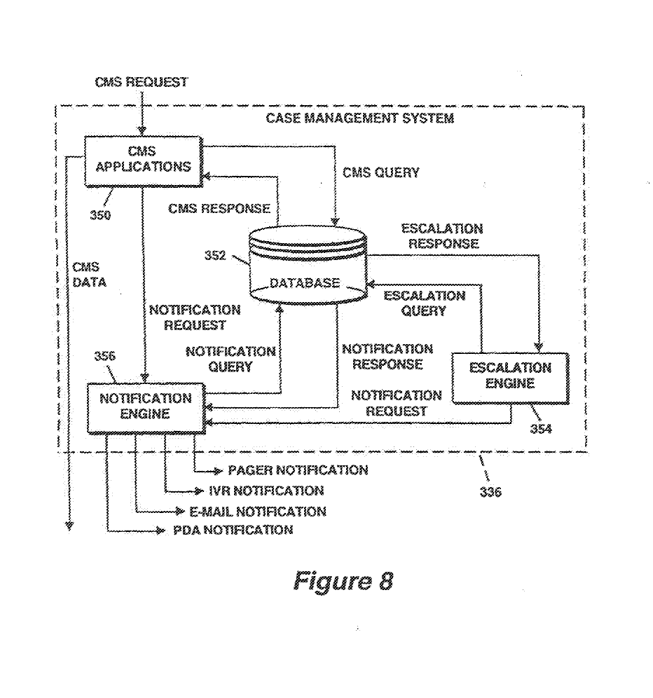

As described with reference to FIGS. 3A and 4-10, appliance 300 comprises a Status Poller which periodically polls one or more monitored network objects and receives fault responses thereto. A Trap Receiver receives device generated fault messages. Both the Trap Receiver and Status Poller generate and transmit decision requests to the decision engine. The decision engine verifies through on-demand polling that a device is down. A root cause analysis module utilizes status and dependency data to locate the highest object in the parent/child relationship tree that is affected to determine the root cause of a problem. Once a problem has been verified, a “case” is opened and notification alerts may be sent out to one or more devices. The decision engine interacts with the database and the case management module to monitor the status of problems or “cases” which have been opened. The case management module interacts with the various notification devices to provide the status updates and to provide responses to queries.

The status of a monitored object is maintained in memory using a virtual state machine. The virtual state machines are based on one or a plurality of different finite state machine models. The decision engine receives input data, typically event messages, and updates the virtual state machines accordingly. The inventive network appliance records thousands of network states and simultaneously executes thousands of state machines while maintaining a historical record of all states and state machines.

More specifically, appliance 300 can communicate either directly or remotely with any number of devices, or processes, including the a worldwide web processes 302, a Personal Digital Assistant 304, an e-mail reader process 306, a telephone 308, e.g., either a traditional PSTN telephone or an IP-enabled telephony process 311, and/or a pager apparatus 310. In addition, appliance 300 can communicate either directly or remotely with any number of external management applications 312 and monitored devices 314. Such communications may occur utilizing the network environment illustrated in FIG. 2 or other respective communication channels as required by the receiving or process.

Appliance 300 monitors network objects, locates the source of problems, and facilitates diagnostics and repair of network infrastructure across the core, edge and access portions of the network. In the illustrative embodiment, appliance 300 comprises a status monitoring module 318, a performance monitoring module 316, a decision engine 324, a case management module 326 and database 348. The implementations of these modules as well as their interaction with each other and with external devices is described hereafter in greater detail.

The present invention uses a priori knowledge of devices to be managed. For example, a list of objects to be monitored may be obtained from Domain Name Server. The desired objects are imported into the appliance 300. The relationships between imported objects may be entered manually or detected via an existing automated process application. In accordance with the paradigm of the invention, any deviation from the imported network configuration is considered a fault condition requiring a modification of the source data. In this manner the network management appliance 300 remains in synchronization with the source data used to establish the network configuration.

Status Monitoring Module

A Status Monitoring Module 318 comprises a collection of processes that perform the activities required to dynamically maintain the network service level, including the ability to quickly identify problems and areas of service degradation. Specifically, Status Monitoring Module 318 comprises Status Puller Module 330, On-Demand Status Puller 335, Status Plug-Ins 391, Bulk Plug-In Puller 392, Bulk UDP Puller 394, Bulk ifOperStatus Puller 396, Bulk TCP Puller 398, Bulk ICMP Puller 397, Trap Receiver 332, Status View Maintenance Module 385, and Status Maps and Tables Module 387.

Polling and trapping are the two primary methods used by appliance 300 to acquire data about a network's status and health. Polling is the act of asking questions of the monitored objects, i.e., systems, services and applications, and receiving an answer to those questions. The response may include a normal status indication, a warning that indicates the possibility of a problem existing or about to occur, or a critical indication that elements of the network are down and not accessible. The context of the response determines whether further appliance 300 action is necessary. Trapping is the act of listening for a message (or trap) sent by the monitored object to appliance 300. These trap messages contain information regarding the object, its health, and the reason for the trap being sent.

A plurality of plug-ins and pollers provide the comprehensive interface for appliance 300 to query managed objects in a network infrastructure, Such queries result in appliance 300 obtaining raw status data from each network object, which is the first step to determining network status and health. The various plug-ins and pollers operate in parallel, providing a continuous and effective network monitoring mechanism. Pollers may utilize common protocols such as ICMP (Ping), SNMP Get, Telnet, SMTP, FTP, DNS, POP3, HTTP, HTTPS, NNTP, etc. As a network grows in size and complexity, the intelligent application of polling and trapping significantly enhances system scalability and the accuracy of not only event detection, but also event suppression in situations where case generation is not warranted.

Status Poller

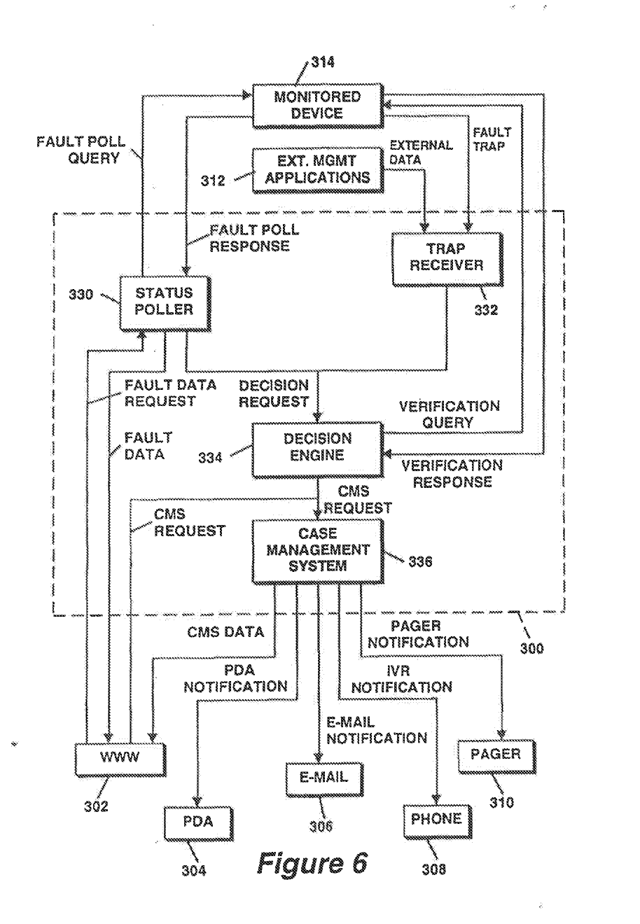

Fault detection capability in appliance 300 is performed by Status Poller 330 and various poller modules, working to effectively monitor the status of a network. Status Poller 330 controls the activities of the various plug-ins and pollers in obtaining status information from managed devices, systems, and applications on the network. FIG. 6 illustrates the status flow between network appliance 300 and external network elements. Status Poller 330 periodically polls one or more monitored devices 314A-N. Status Poller 330 generates a fault poll query to a monitor device 314 and receives in return, a fault poll response. The fault poll queries may be in the form of any of a ICMP Echo, SNMP Get, TCP Connect or UDP Query. The fault poll response may be in the form of any of a ICMP Echo Reply, SNMP Response, TCP Ack or UDP Response. Status Poller 330 may also receive a fault data request in URL form from web process 302. In response, Status Poller 330 generates and transmits fault data in HTML format to web process 302. Status Poller 330 generates decision requests for decision engine 334 in the form of messages. In addition, Status Poller 332 receives external data from an external management application 312. Trap Receiver 332 receives device generated fault messages from monitored devices 314. Both Trap Receiver 332 and Status poller 330 generate decision requests for decision engine 334 in the form of messages.

Status Poller 330 determines the needed poll types, segregates managed objects accordingly, and batch polls objects where possible. A Scheduler 373 triggers the Status Poller 330 to request polling at routine intervals. During each polling cycle, each monitored object is polled once. If any objects test critical, all remaining normal objects are immediately polled again. A Dependency Checker module which is part of the Root Cause Analysis Module determines which objects have changed status from the last time the Status Poller 330 was run, and determines, using the current state objects and the parent/child relation data, which objects are “dependency down” based on their reliance on an upstream object that has failed. This process repeats until there are no new critical tests found. Once the polling cycle is stable, a “snapshot” of the network is saved as the status of the network until the next polling cycle is complete. The network status information obtained is written into database 352 for use by other processes, such as the Decision Engine 334 when further analysis is required.

Polling a network for status information is an effective method of data gathering and provides a very accurate picture of the network at the precise time of the poll, however, it can only show the state of the network for that moment of time. Network health is not static. A monitored object can develop problems just after is has been polled and reflected a positive operational result. Moreover, this changed status will not be known until the device is queried during the next polling cycle. For this reason appliance 300 also incorporates the use of the Trap Receiver 332 to provide near real-time network status details.

Trap Receiver

A trap is a message sent by an SNMP agent to appliance 300 to indicate the occurrence of a significant event. An event may be a defined condition, such as a link failure, device or application failure, power failure, or a threshold that has been reached. Trapping provides a major incremental benefit over the use of polling alone to monitor a network. The data is not subject to an extended polling cycle and is as real-time as possible. Traps provide information on only the object that sent the trap, and do not provide a complete view of network health. Appliance 300 receives the trap message via Trap Receiver 332 immediately following the event occurrence. Trap Receiver 332 sends the details to Status View Maintenance Module 385, which requests the Status Poller 330 to query the network to validate the event and locate the root cause of the problem. Confirmed problems are passed to Case Management Module 326 to alert network management personnel.

The On-Demand Status Poller 335 provides status information to Decision Engine 334 during the verification stage. Unlike the Status Poller 330, On-Demand Status Poller 335 only polls the objects requested by the Decision Engine 334. Since this is usually a small subset of objects, the status can typically be found more quickly. The responses from these polls are fed back to the Decision Engine 334 for further processing and validation.

The Status View Maintenance Module 385 provides a gateway function between the Status Poller 330, and Root Cause Analysis and the Decision Engine Modules. The Status View Maintenance Module 385 controls the method by which network status information is created, maintained, and used. It serves as the primary interface for the depiction of network status details in the Status Maps and Status Table 387. Detailed object status information is presented through four (4) statuses: raw, dependency, decision, and case.

The Status Maps and Tables Module 387 is used to generate representations of complex relationships between network devices, systems, services and applications. Status Maps and Tables Module 387 works in conjunction with web server application 381using known techniques and the HTML language to provide a web accessible user interface to the data contained in database 352. A Status Map depict the precise view of managed objects and processes as defined during the implementation process. The Status Map provides a fast and concise picture of current network issues, providing the ability to determine the specific source of network failure, blockage or other interference. Users can zoom to the relevant network view, and launch an object-specific Tools View that assists in the diagnostics and troubleshooting process and may include links to third party management tools, such as Cisco Resource Manager Essentials (RME), etc.

A Status Table enables a tabular view of managed network infrastructure. All managed network components 314 can be displayed individually, or assembled under categories according to device type, location, or their relationship to the monitoring of Groups of objects representing complete processes or other logical associations. As described in the User Interface section hereafter, a series of unique status icons clearly depict the operational state of each object, with the option to include more comprehensive status views including greater details on the various process elements for managed objects.

Status Plug-Ins/Bulk Pollers

As will be understood by those skilled in the arts, a plug-in, as used herein, is a file containing data used to alter, enhance, or extend the operation of an parent application program. Plug-ins facilitate flexibility, scalability, and modularity by taking the input from the a proprietary product and interfacing it with the intended application program. Plug-in modules typically interface with Application Program Interfaces (API) in an existing program and prevent an application publisher from having to build different versions of a program or include numerous interface modules in the program. In the present invention plug-ins are used to interface the status poller 335 with monitored objects 314.

The operation of plug-ins and bulk pollers is conducted at routine intervals by the Status Poller Module 330, and, on an as-needed basis, by the request of the On-Demand Status Poller Module 335. In the illustrative embodiment, the primary status plug-ins and pollers include Status Plug-Ins 391, Bulk Plug-In Poller 392, Bulk UDP Poller 394, Bulk ifOperStatus Poller 396, Bulk TCP Poller 398 and Bulk ICMP Poller 397.

Status Plug-Ins 391 conduct specific, individual object tests. Bulk Plug-In Poller 392 makes it possible to conduct multiple simultaneous tests of plug-in objects. Unlike many network management systems that rely solely on individual object tests, the Bulk Plug-In Poller 392 enables a level of monitoring efficiency that allows appliance 300 to effectively scale to address larger network environments, including monitoring via SNMP (Simple Network Management Protocol). Used almost exclusively in TCP/IP networks, SNMP provides a means to monitor and control network devices, and to manage configurations, statistics collection, performance, and security.

Bulk UDP Poiler 394 is optimized to poll for events relating to UDP (User Datagram Protocol) ports only. UDP is the connectionless transport layer protocol in the TCP/IP protocol stack. UDP is a simple protocol that exchanges datagrams without acknowledgments or guaranteed delivery, requiring that error processing and retransmission be handled by other protocols. Bulk UDP Poller 394 permits multiple UDP polls to be launched within the managed network.

Bulk ifOperStatus Poller 396 monitors network infrastructure for the operational status of interfaces. Such status provides information that indicates whether a managed interface is operational or non-operational.

Bulk TCP Poller 398 polls for events relating to TCP (Transmission Control Protocol) ports only. Part of the TCP/IP protocol stack, this connection-oriented transport layer protocol provides for full-duplex data transmission. Bulk TCP Poller 398 permits multiple TCP polls to be launched within the managed network.

Bulk ICMP Poller 397 performs several ICMP (ping) tests in parallel. Bulk ICMP Poller 397 can initiate several hundred tests without waiting for any current tests to complete. Tests consists of an ICMP echo-request packet to an address. When an ICMP echo-reply returns, the raw0 status is deemed normal. Any other response or no answer within a set time generates a new echo-request. If an ICMP echo-reply is not received after a set number of attempts, the raw status is deemed critical. The time between requests (per packet and per address), the maximum number of requests per address, and the amount of time to wait for a reply are tunable by the network administrator using appliance 300.

Performance Monitoring Module

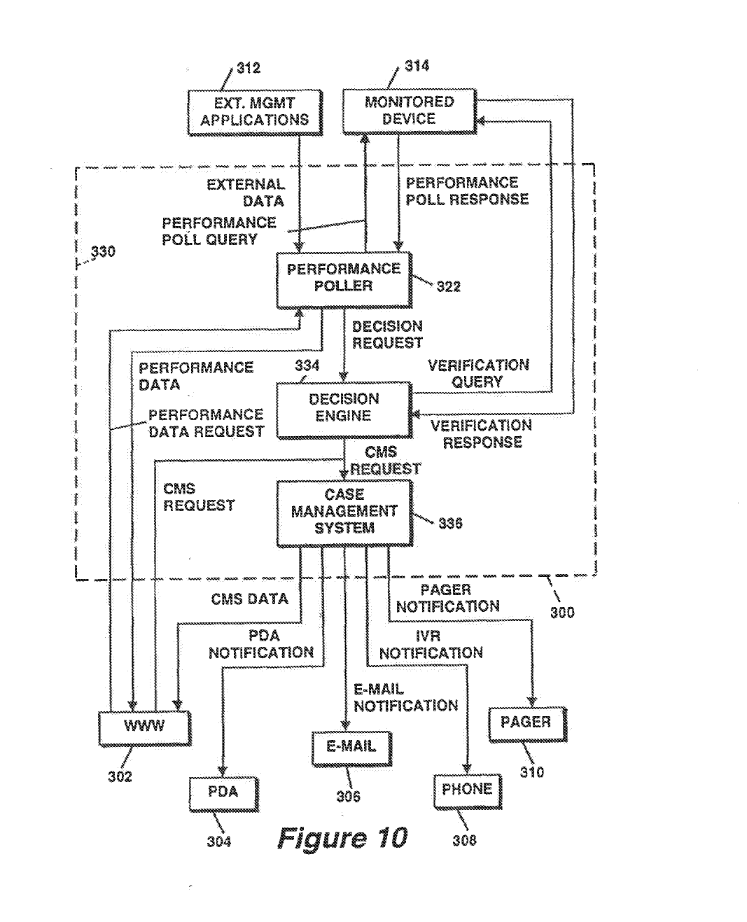

The primary component of performance monitoring module 316 is performance poller 322. Performance poller 322 is the main device by which appliance 300 interacts with monitored device(s) 314a-n and is responsible for periodically monitoring such devices and reporting performance statistics thereon. Performance poller 322 is operatively coupled to application(s) 312, monitored device(s) 314, decision engine 334 and web process(es) 302. FIG. 10 illustrates the communication flow between the performance poller 322 and decision engine 334, as well as external elements. Performance poller 322 polls monitored device(s) 314a-n periodically for performance statistics. Specifically, performance poller 322 queries each device 314 with an SNMP Get call in accordance with the SNMP standard. In response, the monitored device 314 provides a performance poll response to performance poller 322 in the form of an SNMP Response call, also in accordance with the SNMP standard.

Based on the results of the performance poll response, performance poller 322 generates and transmits decision requests to decision engine 334 in the form of messages. Such decision requests may be generated when i) a specific performance condition occurs, ii) if no response is received within predefined threshold, or iii) if other criteria are satisfied. Decision engine 334 is described in greater detail hereinafter. In addition, one or more external management applications 312 provide external management data to performance poller 322 in the form of messages.

In the illustrative embodiment, performance poller 322 may have an object-oriented implementation. Performance poller 322 receives external data from applications 312 through message methods. Such external applications may include Firewalls, Intrusion Detection Systems (IDS), Vulnerability Assessment tools, etc. Poller 322 receives performance data requests from web process 302 via Uniform Resource Locator (URL) methods. In response, poller 322 generates performance data for web process 302 in the form of an HTML method. In addition, poller 322 receives performance poll response data from a monitored device 314 in the form of an SNMP response method. In addition, poller 322 receives performance poll response data from a monitored device 314 in the form of an SNMP response method. As output, poller 322 generates a performance poll query to a monitored device 314 in the form of an SNMP Get method. Performance poller 322 generates decision requests to decision engine 334, in the form of a message.

Performance Poller 322 obtains performance data from network devices and applications, creating a comprehensive database of historical information from which performance graphs are generated through the user interface of appliance 300, as described hereafter. Such graphics provide network management personnel with a tool to proactively monitor and analyze the performance and utilization trends of various devices and applications throughout the network. In addition, the graphs can be used for diagnostics and troubleshooting purposes when network issues do occur.

A series of device-specific Performance Plug-Ins 321 serve as the interface between the Performance Poller 322 and managed network objects. The performance criteria monitored for each component begins with a best practices of network management approach. This approach defines what elements within a given device or application will be monitored to provide for the best appraisal of performance status. The managed elements for each device or application type are flexible, allowing for the creation of a management environment that reflects the significance and criticality of key infrastructure. For instance, should there be an emphasis to more closely monitor the network backbone or key business applications such as Microsoft® Exchange, a greater focus can be placed on management of this infrastructure by increasing the performance criteria that is monitored. Likewise, less critical infrastructure can be effectively monitored using a smaller subset of key performance criteria, while not increasing the management complexity caused by showing numerous graphs that are not needed.

Once the performance management criterion is established, the Performance Plug-Ins are configured for each managed device and application. Performance elements monitored may include, but are not limited to, such attributes as CPU utilization, bandwidth, hard disk space, memory utilization, or temperature. Appliance 300 continuously queries managed or monitored objects 314 at configured intervals of time, and the information received is stored as numeric values in database.

Event Processing

The appliance 300 architecture comprises sophisticated event processing capability that provides for intelligent analysis of raw network event data. Instead of accumulating simple status detail and reporting all network devices that are impacted, appliance 300 attempts to establish the precise cause of a network problem delivering the type and level of detail that network management personnel require to quickly identify and correct network issues. The primary components of event processing capability in appliance 300 are the Root Cause Analysis Module 383 and the Decision Engine 334.

Root Cause Analysis

When a change in network status is observed that may indicate an outage or other issue, the Status Poller 330 presents the to the Root Cause Analysis module 383 for further evaluation. During the course of a network problem or outage, this may consist of tens or even hundreds of status change event messages. These numerous events may be the result of a single or perhaps a few problems within the network.

The Root Cause Analysis Module 383 works directly with the Decision Engine 334 during the event evaluation process. Appliance 300 first validates the existence of an event and then identifies the root cause responsible for that event. This process entails an evaluation of the parent/child relationships of the monitored object within the network. The parent/child relationships are established during the implementation process of appliance 300, where discovery and other means are used to identify the managed network topology. A parent object is a device or service that must be functional for a child device or service to function. A child object is a device or service that has a dependency on a parent device or service to be functional. Within a network environment a child object can have multiple parent objects, and a parent object can have multiple children objects. In addition, the parent and child objects to a node or monitored object may be located at the same or different layers of the OSI network protocol model across the computer network. Because of this, a Dependency Checker function within Root Cause Analysis Module 383 performs a logical test on every object associated with a monitored object in question to isolate the source of the problem. When appliance 300 locates the highest object in the parent/child relationship tree that is affected by the event it has found the root cause of the problem.

Case Management System

The Case Management system 336 is an integral component of appliance 300 and provides service management functionality. Whereas the Decision Engine 334 works behind the scenes to identify and validate faults, Case Management system 336 is the interface and tool used to manage information associated with the state of the network. Case Management system 336 provides a process tool for managing and delegating workflow as it relates to network problems and activities. The Case Management generates service cases (or trouble tickets) for presentation and delivery to network management personnel.

Case management system 336 comprises a CMS application module 350, a database 352, a notification engine 356 and an escalation engine 354, as illustrated. CMS application module 350 comprises one or more applications and perform the CMS functionality, as explained hereinafter. CMS applications 350 receive CMS requests, in the form of URL identifiers from decision engine 334. In response, CMS applications 350 generate and transmit notification requests to notification engine 356, in the form of messages. CMS applications 350 generate and transmit CMS data to a worldwide web process 302 in the form of HTML data. Database 352 receives CMS queries from CMS applications 350 in the form of messages and generates in response thereto a CMS response in the form of a message, as well. In addition, database 352 receives notification queries from notification client 364, in the form of messages and generates, in response there, notification responses to notification client 364 in the form of messages as well.

Case Management system 336 accommodates Auto cases and Manual cases. Cases passed to the Case Management System from the Decision Engine Module appear as AutoCases. These system-generated cases are associated with a network problem. Appliance 300 has determined that the node referenced in the case is a device responsible for a network problem, based on the findings of Root Cause Analysis and the Decision Engine 334. The Auto Case is automatically assigned an initial priority level that serves until the case is reviewed and the priority is modified to reflect the significance of the problem relative to the network impact and other existing cases being handled.

Cases entered into Case Management system 336 by the network manager or network management personnel are called Manual Cases. This supports the generation, distribution, and tracking of network work orders, or can aid in efforts such as project management. Using a web browser, personnel can obtain the case data from either on-site or remote locations, and access a set of device-specific tools for diagnostics and troubleshooting. Unlike other general-purpose trouble ticketing systems, the appliance 300 has case management capabilities are specifically optimized and oriented to the requirements of network management personnel. This is reinforced in both the types and level of information presented, as well as the case flow process that reflects the specific path to network issue resolution. Opening a case that has been generated shows the comprehensive status detail such as the impacted network node, priority, case status, description, and related case history. The network manager or other personnel can evaluate the case and take the action that is appropriate. This may include assigning the case to a network engineer for follow-up, or deleting the case if a device has returned to fully operational status.

The main Case Management screen of the user interface provides a portal through web server application 381 from which all current case activity can be viewed, including critical cases, current priority status, and all historical cases associated to the specific object. Case data is retained in appliance 300 to serve as a valuable knowledge-base of past activity and the corrective actions taken. This database is searchable by several parameters, including the ability to access all cases that have pertained to a particular device. A complete set of options is available to amend or supplement a case including: changing case priority; setting the case status; assigning or re-assigning the case to specific personnel; correlating the case to a specific vendor case or support tracking number, and updating or adding information to provide further direction on actions to be taken or to supplement the case history.

Escalation engine 354 tracks escalations and requests notifications as needed. Escalation engine 354 generates and transmits escalation queries to database 352 in the form of messages and receives, in response thereto, escalation responses in the forms of messages. In addition, escalation engine 354 generates and transmits notification requests, in the form of messages, to notification server 360 of notification engine 356, in the form of messages. Automated policy-based and roles-based case escalation processes ensure that case escalations are initiated according to defined rules and parameters. Cases not responded to within pre-established time periods automatically follow the escalation process to alert management and other networking personnel of the open issue.

Notification Engine

When a new auto case or manual case is generated or updated, appliance 300 initiates a notification process to alert applicable network personnel of the new case. This function is provided through Notification Engine 356. Appliance 300 utilizes a configurable notification methodology that can map closely an organization's specific needs and requirements. Appliance 300 incorporates rules- and policy-based case notification by individual, role, or Group, and includes additional customizability based on notification type and calendar. Supported notification mechanisms include various terminal types supporting the receipt of standard protocol text messaging or e-mail, including personal computer, text pager, wireless Personal Digital Assistant (PDA), and mobile phones with messaging capability. The e-mail or text message may contain the important details regarding the case, per the notification content format established in system configuration.

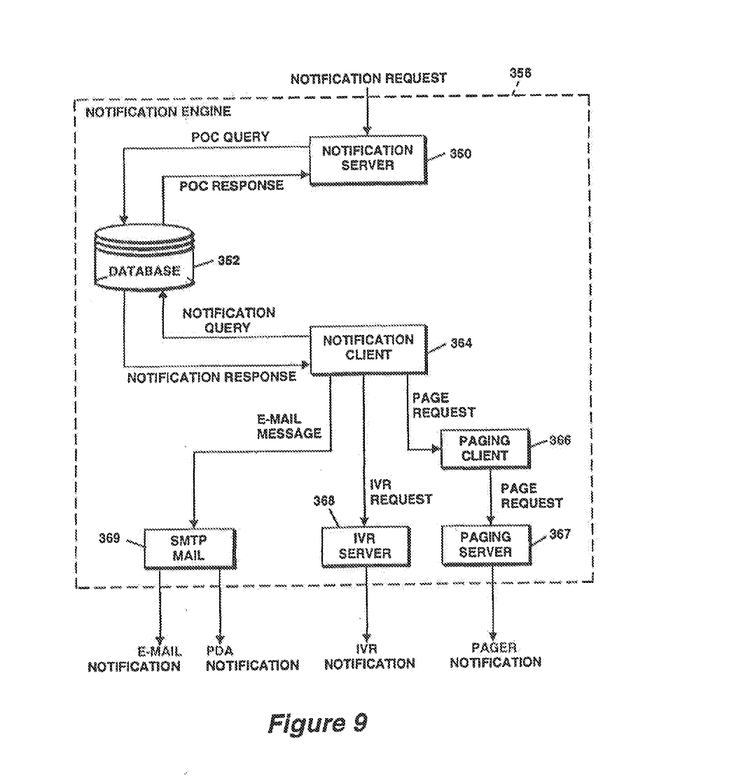

As illustrated in FIG. 9, notification engine 356 comprises notification server 360, database 352, notification client 364, paging client 366, paging server 367, Interactive Voice Response (IVR) server 368 and SMTP mail module 369. Notification engine 356 generates notifications via e-mail and pager as necessary. Notification server 360 accepts notification requests, determines notification methods, and stores notifications in database 352. As stated previously, notification server 360 receives notification requests from CMS applications 350. Notification server generates and transmits Point Of Contact (POC) queries in the form of messages to database 352 and receives, in response thereto, POC responses, also in the form of messages. Notification client 364 generates notifications using appropriate methods. Notification client 364 generates and transmits notification queries, in the form of messages, to database 352 and receives in response thereto notification responses, also in the form of messages. In addition, notification client 364 generates and transmits page requests in the form of messages to paging client 366. Notification client 364 further generates, in the form of messages, IVR requests to IVR server 368 and e-mail messages to SMTP mail module 369. Paging client 366 receives page requests from notification client 364 and forwards the page requests onto page server 367. Paging server 367 generates pager notifications, in the form of messages, to a pager device 310. Paging server 367 accesses a TAP terminal via a modem or uses the Internet to forward the pager notification. IVR server 368 receives IVR requests and calls phone 308 via an IVR notification in the form of a telephone call which may be either packet-switched or circuit-switched, depending on the nature of the terminating apparatus and the intervening network architecture. SMTP mail module 369 processes notifications via e-mail and acts as a transport for paging notifications. SMTP mail module 369 generates messages in the form of e-mail notifications to e-mail process 306 and PDA notifications to personal digital assistant device 304.

Decision Engine

Decision Engine 334 is an extensible and scaleable system for maintaining programmable Finite State Machines created within the application's structure. Decision Engine 334 is the portion of system architecture that maintains the intelligence necessary to receive events from various supporting modules, for the purpose of verifying, validating and filtering event data. Decision Engine 334 is the component responsible for reporting only actual confirmed events, while suppressing events that cannot be validated following the comprehensive analysis process.

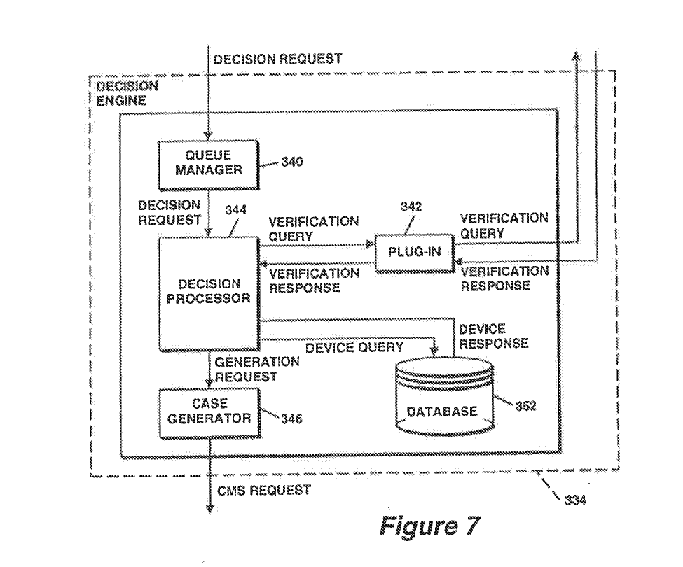

Referring to FIG. 7, decision engine 334 comprises, in the illustrative embodiment, a queue manager 340, decision processor 344, case generator 346, database 352 and one or more plug in modules 342. As illustrated, decision engine 334 receives decision requests from any of Performance poller 322, Status Poller 330 or Trap Receiver 332, in the form of messages. A queue manager 340 manages the incoming decision requests in a queue structure and forwards the requests to decision processor 344 in the form of messages. Decision processor 344 verifies the validity of any alarms and thresholds and forwards a generation request to case generator request 346 in the form of a message. Case generator 346, in turn, compiles cases for verification and database information and generates a CMS request which is forwarded to case management system 336, described in greater detail hereinafter.

In addition, decision processor 344 generates and transmits device queries in the form of messages to database 352. In response, database 352 generates a device response in the form of message back to decision processor 344. Similarly, decision processor 344 generates and transmits verification queries in the form of messages to plug in module 342. In response, module 342 generates a verification response in the form of a message back to decision processor 344. Plug in module 342 generates and transmits verification queries in the form of messages to a monitored device 314. In response, monitored device 314 generates a verification response in the form of a message back to plug-in module 342.

Decision engine 334 may be implemented in the C programming language for the Linux operating system, or with other languages and/or operating systems. Decision engine 334 primarily functions to accept messages, check for problem(s) identified in the message, and attempts to correct the problem. If the problem cannot be corrected the decision engine 334 opens a “case”. In the illustrative embodiment, decision engine 334 may be implemented as a state-machine created within a database structure that accepts messages generated by events such as traps and changes state with messages. If the decision engine reaches certain states, it opens a case. The main process within the decision engine state-machine polls a message queue and performs the state transitions and associated tasks with the transitions. Events in the form of decision requests are processed by the decision engine/virtual state-machine. The decision module/virtual state-machine processes the request and initiates a verification query. The verification response to the verification query is processed by the decision module/virtual state-machine. Based on the configuration of the decision module/state-machine the decision module/state machine initiates a case management module case request. Events are polls, traps, and threshold violations generated by the status poller, fault trapper, and performance poller respectively.

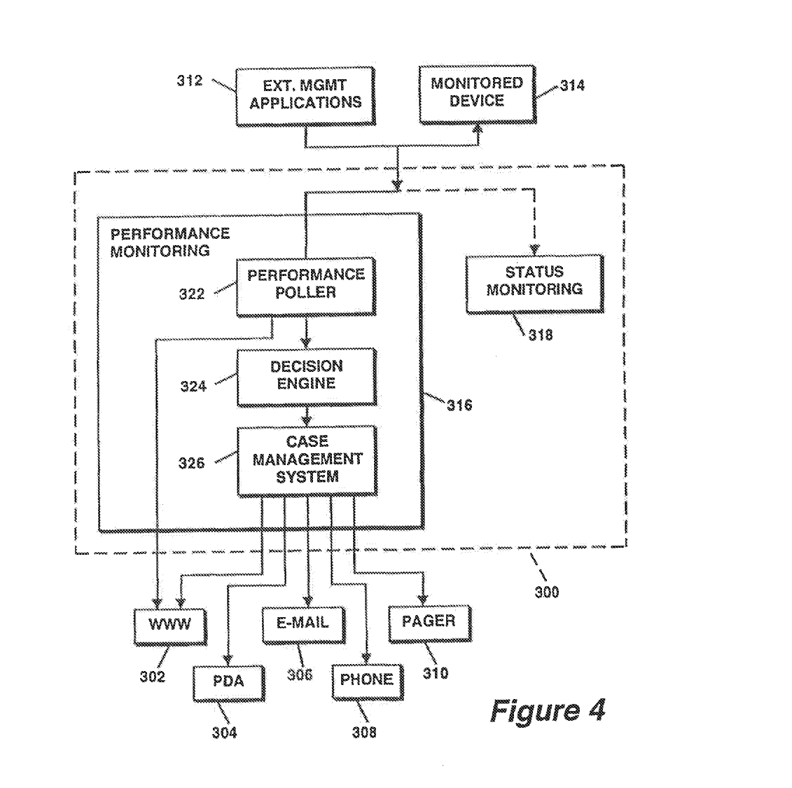

As shown in FIG. 11, decision engine 334 comprises several continuously running processes or modules including populate module 380, command module 382, decision module 384, variable module 386, on demand status poller module 388, and timer module 390, described in greater detail hereinafter. These processes may launch new processes when required. In the illustrative embodiment, these processes share database tables in database 352 as a means for communication by accessing and manipulating the values within the database. In FIGS. 4-6 and 10, the functions of Decision Engine 334 are performed by command module 382, decision module 384, variable module 386, on demand status poller module 388, and timer module 390, described in greater detail hereinafter. In FIG. 7, the functions of Decision Processor 344 are performed by decision module 384, variable module 386, on demand status poller module 388, and timer module 390. The functions of Case Generator 346 is performed by command module 382.

Populate Module

The populate module 380 creates and initializes the state machine(s) to the “ground” state for each managed object 314 whenever a user commits changes to their list of managed objects. In the illustrative embodiment, unless purposefully overridden, the populate module 380 will not overwrite the current machine state for a managed object. Otherwise, notifications could be missed. Also, the deletion of an object upon a commit results in the deletion of all state machines, timers, and variables associated with the object to prevent unused records and clutter in database 352.

Command Module

The command module 382 retrieves records from the command table, performs the task defined in a database record, and, based on the result returned by the command, places a message in the message queue, i.e. the Message Table. In the illustrative embodiment, a command can be any executable program, script or utility that can be run using the system( ) library function.

In illustrative embodiment, the command module 382 may be implemented in the C programming language as a function of a Decision Engine object and perform the functions described in the pseudo code algorithm set forth below in which any characters following the “#” symbol on the same line are comments:
while TRUE loop forever retrieve the record that has been sitting in the commands_queue table for the longest period of time

use the system command (or some other as yet to be determined method) to execute the command found in the action field of the current record. The argument list for action will be build using the values found in the host, poll, instance, and argument fields of the current record, Upon completion of the command, if the message found in the message field is not blank, put the message into the message queue. #end loop forever

Decision Module

The decision module 384 retrieves messages from the message queue, determines which state machine the message is intended for, changes the state of the machine based on the content of the message, and “farms out” to the other modules the tasks associated with the state change. In the illustrative embodiment, a task has associated therewith a number of optional components including a type, action, arguments, condition and output message.

In order to provide additional flexibility to the arguments field of the active_timers, command_queue, and variable_queue tables, the arguments field in the transition_functions and state_functions tables may be allowed to contain patterns that can match any of the field names found in the messages table or the value of any varName field in the variables table. When a matching pattern is found it is replaced with the value from the messages table field that the pattern matches or, if the pattern matches a varName field in the variables table, the pattern is replaced with the appropriate value from the from the value field in the variables tables.

On Demand Status Poller Module

The on demand status poller module 388 retrieves records from the status_request table with a user defined frequency, e.g. every 10 seconds. The module improves efficiency by batching status requests which will all be “launched” at the same time. The retrieved status requests are “farmed out” to the appropriate poller module. The on demand status poller module 388 waits for the results of the status requests to be returned by the pollers. Based on the result, the appropriate message is inserted into the message queue.

Timer Module

The timer module 390 retrieves records from the active_timers table, performs the tasks defined in the record, and, upon completion of the task, puts the associated message into the message queue. Currently defined tasks include expiring a timer and clearing a timer. If present in the current timer record, a condition has to be met before the message is put into the message queue. An example condition would be “UNIX_TIMESTAMP>exp_time”, which checks to see if a timer has expired.

One or more of the above described processes or modules, including populate module 380, command module 382, decision module 384, variable module 386, on demand status poller module 388, and timer module 390, operate in conjunction to collectively perform the functions the elements of decision engine 334 and other elements of appliance 300 as noted herein.

Finite and Virtual State Machines

In the illustrative embodiment, messages are the mechanism to make a state machine change state, in addition to control messages to initialize state machines or to forcefully change state. Messages arrive from a message queue. At any time only the active states can accept messages. Only one state is active (active=1) and all other states are inactive (active=0). If no active state can accept the message, the message is discarded. Initially, the state machine is at ground state, meaning the ground state is the only active state. After handling of the message, the machine returns to the ground state again.

A state machine will frequently request waiting before changing states. Instead of launching new processes for each wait request, a single timer process operating on a set of timers may do the same job with much less resource. A special timers table is employed for that purpose. Since a unique id for each timer is needed, a timestamp may also be used for that purpose. The timer process operates on the timers table by checking for the expiration of timers and if the current time is past expiration, deletes the entry from table and inserts the message into the message queue.

Given a fundamental understanding of state machines and how their respective states can be changed using message input, the finite state machine models on which all the virtual state machines used within the appliance 300 are is described hereafter. Records contained within database 352 define several finite state machine models managed by decision engine 334.

Finite State Machines

Decision Engine 334 is designed to optimize resource utilization, allow for the launching of multiple Finite State Machines, and conduct multiple activities simultaneously. Decision Engine 334 can be used to perform any decision making process which can be modeled by a Finite State Machine. A finite state machine model in accordance with the illustrative embodiment may be defined by the following:
A finite set of states. Each state represents a condition or step in the decision process. Only one state in each machine may be active at a time, and this is referred to as the ‘Current State’
A finite set of inputs. (events that trigger state changes and the execution of actions) Inputs are represented as messages pertaining to objects, providing the events that trigger state changes and the execution of actions. Any message that does not have a Current State with a transition waiting (listening) for it will be considered invalid and discarded. This provides the validation process for the Decision Engine 334. An infinite number of possible messages are filtered to allow only a finite number of messages through when they are valid.
Finite set of transitions. Given a particular state and a particular message, transfer is facilitated to the next state. At the point in time when the transition occurs, it can initiate any tasks defined for the transition and target state. Each transition is uniquely defined by the ‘Current State, Message and Destination State’.
Set of transition tasks that define zero or more actions that are to be performed based on the current state and input received (e.g., anytime current state is ‘StateA’ and the input ‘MessageA’, perform the transition tasks for ‘StateA, MessageA.’ For example, actions may include launching the On-Demand Status Poller Module to recheck the status of an object, setting a timer, and opening a case that identifies an object as being critical.
Set of state tasks that define zero or more actions that are to be performed based on the next state independent of the input or current state (e.g., anytime the target state is ‘StateA’ perform the state tasks for ‘StateA’).

To keep the number of records in database 352 manageable no matter how large the number objects managed by apparatus 300, each type of finite state machine is defined only once. For each managed object 314 a virtual state machine comprising the name of the object, the type of state machine and the current state of the state machine is added to and maintained by database 352. As events are received, the decision engine 334 uses database 352 to “look up” the next state and the actions to be performed in the tables and records that define the state machines.

The inventive network appliance 300 reduces false positives through use of the state machines, When a device is first reported down, appliance 300 doesn't alert the end user that the device is down without confirmed verification. This process is done by waiting a certain amount of time and re-polling the device. If the second poll shows that the device is still down, appliance 300 sends out an alert. This process of verifying statuses before reporting alarms is facilitated by the Decision Engine 334 and the state machines associated with the monitored device.

Decision Engine 334 uses the specially designed finite state machines to verify that monitored objects identified as critical by the Status Poller Module and Dependency Checker are in fact down. Decision Engine 334 then performs such functions as: Initiating detailed information in support of new case generation for the down object, or status updates to existing cases at specific time intervals for impacted objects, including device- or condition-specific messages that are provided by the state machine; updating existing cases when objects become available; and suppressing case updates for monitored objects that have exceeded a defined number of updates within a prescribed period of time.

As will be obvious to those reasonably skilled in the arts. Other state machine models may be accommodated by appliance 300 and used similarly without significant reconfiguring of the device beyond recompiling of the appropriate code segments. Extensibility is accomplished by allowing new and enhanced finite state machine models to be quickly developed and introduced without the need to change system code. For example, if a new Finite State Machine is needed because a new type of status poll has been created to better monitor or manage a specific object, the definition of this new State Machine does not require a change to the appliance 300 application software. Once the new State Machine is added to the system, any managed object that is of the new status poll type will be handled by the Decision Engine without requiring recompilation of any part of the underlying Decision Engine code. In addition, the functionality of the Decision Engine can be extended by its ability to run any program, script or utility that exists on the appliance 300 application. This function can be applied to instances such as when a process managed by appliance 300 is identified as “down”, the Finite State Machine for that object can be designed to run a command that will attempt to restart the process without human intervention.

The virtual state machines provide a significant scaling advantage as compared to traditional state machines. Implementation of virtual state machines within a database solves several constraints including constraints associated with memory resident state machines implemented in RAM. With the memory constraint removed, the number of virtual state machines maintained concurrently may be increased by orders of magnitude. In addition, implementation of virtual machines in memory rather that as executing processes, allows the state data of monitored objects to be retained through a loss of power by the network appliance.

Decision Process

In terms of decision process, the Decision Engine 334 receives potential issues and supporting details following Root Cause Analysis. The defined Finite State Machine(s) for the identified objects are invoked to supplement the discovery and validation process. Based on its instructions, the Decision Engine 334 then seeks to validate the status of the device as well as other surrounding devices through the On-Demand Status Poller Module 335. The On-Demand Status Poller 335 returns status details to the Decision Engine 334 where the results are evaluated further. Once a network issue has been isolated and validated, the source of the problem and other supporting detail is passed to the Case Management system 336, which is the primary component of appliance 300's Service Management capability. Additionally, the status details relating to the root cause and devices affected through dependency are provided to the Status View Maintenance Module 385, which depicts the status in the Network Status Table and Status Maps 387. The various appliance 300 modules continue this course of action and provide updates to both cases and status indications as status conditions change.

The Status Poller polls managed objects and awaits a response within system defined parameters. Should a response not be received, the event is forwarded to the decision engine for further analysis, Concurrently, the Trap Receiver system fault trapper will collect and forward trap information to the decision engine for further analysis. The output of the decision engine is a validated problem requiring action or acknowledgement by a human operator. The decision engine uniquely identifies the problem for documentation. At a minimum the uniqueness of the problem is established by identifying the managed object effected and providing a date and time stamped description of the validated problem. The validated problem may be enhanced by further identifying the decision engine as the initiator of the problem, identifying the status of the problem, and assigning a priority to the problem. Any combination of fields within the database may be used to develop a list of problems and the order in which the problems should be addressed. For example, the database may be configured to sort and list problems by priority and date/time stamp. Thus the human technician may view a list of problems with priority one problems, sorted by age, at the top of the list. The human operator typically will document all actions taken. Actions taken will be date/time stamp and chronologically listed within the problem description along with all machine-generated information. Thus the documentation/notification engine will have recorded machine generated validated problems along with human actions within a self contained, chronological description of the problem and all actions through resolution.

The inventive appliance suppresses the generation of additional problems or cases by appending to existing problems previously identified. For example, the inventive decision engine can be configured to search for an unresolved problem previously opened by the decision engine for a specific managed object. By appending information to the existing problem the intended viewer of the problem text, i.e. the human technician, can view all machine and human generated information within its chronological context. This method significantly reduces event storms that typically inundate network management systems. Specifically, objects that continuously flap from a “known good state” to a “fault” state typically generate events associated with the transition from “known good state” to “fault” state. The inventive appliance will suppress such event storms by logically grouping all such events within one unresolved problem associated with the root cause object.

User Interface

The appliance 300 includes a web server process 381 which generates a user interface which includes a number of menu selectable options and can dynamically generate a visual representation of the current state of managed objects and the Boolean relationships between objects at different layers of the Open Systems Interconnect network protocol model. In the illustrative embodiment, web server process 381 may be implemented a commercially available products such as the Apache Web server product. The dynamically generated visual representation of a managed object can scaled down to display the desired number of upstream and downstream objects from the target object, in a manner as illustrated in FIGS. 13-15 and 22 of previously cited U.S. Pat. Nos. 7,971,106; 7,600,160; 7,509,540; 7,296,194; 7,197,561; 7,069,480; and 7,028,228. Data regarding a monitored object(s) can be viewed in the format of a Status Map or a Status View, as described hereafter.

The diagrams illustrated in FIGS. 13-15 of these patents are generated dynamically upon request from the user. Status Table and Status Map Module 387 within appliance 300 accesses the records within database 352 to determine the upstream and downstream devices for a selected node and their relationships thereto. The Module 387 queries the portion of database 352 which maintains the virtual state machines for the selected node and its respective parent and child nodes. The diagram is then generated from this information to accurately reflect the current configuration and status of all managed objects in the conceptual diagram.

Alternatively, a map of the entire network may be generated and stored statically in database 352 or other memory and updated periodically. In this embodiment, only the selected node and its data string of managed objects (i.e., devices on which it is dependent) will be cross referenced with the virtual state machines prior to display.

From the foregoing description and attached figures, the reader will appreciate that the present invention provides a device which is capable of monitoring the status of complex networks of devices or processes, providing information regarding the status of the network or a specific device through a plurality of different communication channels and displaying accurate visual representations of a node and its immediate relationships in the network, in a manner which is both intuitive and efficient.

Although various exemplary embodiments of the invention have been disclosed, it will be apparent to those skilled in the art that various changes and modifications can be made which will achieve some of the advantages of the invention without departing from the spirit and scope of the invention. For example, although the disclosed system has been described with reference to a Cisco call center environment, it will be obvious to those reasonably skilled in the art that call center environments implemented utilizing other than Cisco protocols and equipment may benefit from the system and techniques described herein.

Further, it will be obvious to those reasonably skilled in the art that modifications to the system, apparatus and process disclosed herein may occur, including substitution of various component and/or substitution of equivalent output functionality, without parting from the true spirit and scope of the disclosure. Still further, it will be obvious to those reasonably skilled in the art that other components performing the same functions may be suitably substituted. The methods of the invention may be achieved in either all software implementations, using the appropriate processor instructions, or in hybrid implementations which utilize a combination of hardware logic and software logic to achieve the same results. Such modifications to the inventive concept are intended to be covered by the disclosure herein and any claims deriving priority from the same.

What is claimed is:

1. A system for monitoring the state of the communications contact center comprising:
A) a network appliance operably coupled to a network and configured for monitoring status of plural objects within a network infrastructure;
B) a contact center state engine operably coupled to a network and configured to:
i) receive communication data from a plurality of sources,
ii) correlate communication data from plural sources relating to a common parameter, and
iii) assimilate the correlated communication data for storage into memory.
wherein exceptions in a state of the contact center as determined by the contact center state engine are corroborated with changes in the status of objects in the network infrastructure, as monitored by the network appliance.

2. A method for monitoring the state of the communications contact center comprising:
A) receiving data either pushed or pulled from a plurality external data sources;
B) correlating a first data type from a first of the plurality of sources with a second data type from a second of the plurality of sources; and
C) associating the first and second data types having a correlation into a third data type utilizing a schema extension which represents metadata of a new metric.

3. The method of claim 2 further comprising:
D) graphically presenting the new metric.

4. The method of claim 2 wherein B) comprises:
B1) determining if the first and second data types are related by a common event.

5. The method of claim 4 wherein B1) comprises:
B1(i) determining if the first and second data types are related to events which occurred within a predefined window of time.

6. The method of claim 6 wherein B1) comprises:
B1(i) determining if the first and second data types are related to events which occurred relative to a predefined threshold.

7. The method of claim 2 wherein B) comprises:
B1) determining if the first and second data types are associated through one of a predefined and user-defined relationship.
